(19) United States
(12) Patent Application Publication
(10) Pub. No.: US 2010/0064290 A1
(43) Pub. Date: Mar. 11, 2010

(54) COMPUTER-READABLE RECORDING MEDIUM STORING A CONTROL PROGRAM, INFORMATION PROCESSING SYSTEM, AND INFORMATION PROCESSING METHOD

(75) Inventors: Seiji Endou, Kawasaki (JP); Taisuke Aizawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/542,403

(22) Filed: Aug. 17, 2009

(30) Foreign Application Priority Data
Sep. 11, 2008 (JP) 2008-233510

(51) Int. Cl. G06F 9/46; G06F 12/14

(52) U.S. Cl. 718/103; 726/27

(57) ABSTRACT

A computer-readable recording medium stores a control program that causes a computer to execute a process that includes: an obtaining procedure for obtaining work procedure manual information about a plurality of ordered works and one or more unordered works associated with a range of a predetermined order; an input step of receiving an input; a recognizing procedure for recognizing whether the first work matches a second work that is initially-ordered in unexecuted ordered works among the plurality of ordered works or a third work associated with a range including the order of the second work among the one or more unordered works; and a control procedure for allowing execution of the first work if the first work matches the second work or the third work and denying execution of the first work if the first work does not match any of the second and third works.

### CROSS-REFERENCE TO RELATED APPLICATIONS

This application is based upon and claims the benefit of priority of the prior Japanese Patent Application No. 2008-233510, filed on Sep. 11, 2008, the entire contents of which are incorporated herein by reference.

### FIELD

The present invention relates to a mandatory access control technique in work support.

### BACKGROUND

Various techniques to support a user by automating or semi-automating processes in an information processing apparatus are known. For example, various applications to provide recording, editing, and reproducing functions using a macro are known.

In typical computers, particularly in a personal computer (PC) used to directly perform operations, a tool to automatically perform a maintenance operation, such as change of settings in the computer and applying modification, is widely used. As a software product for automating the maintenance work, Windows Update by Microsoft Corporation in U.S.A. (“Windows” and “Microsoft” are registered trademarks) and SystemWalker Desktop Patrol (“SystemWalker” is a registered trademark) by the applicant are known.

Also, there exists a demand for automating the maintenance work in a server as well as in the computer, such as a PC for a client. Several techniques of automating a work about maintenance of a server, particularly about applying a modification, and confirming a result of the maintenance work are known.

For example, the following technique of automating a software updating work, including an operation checking work, in a plurality of information processing apparatuses is known. That is, a target selecting unit selects information processing apparatuses having the same configuration as that of a specified information processing apparatus with reference to hardware and software configuration information of information processing apparatuses held in a configuration information database (DB). Then, a software update execution control unit distributes a modification file and a test program to confirm an application result of the modification file to the selected information processing apparatuses. After application of the modification file has been completed, the test program is executed, and execution results are collected and transmitted to a system administrator.

Also, a maintenance work confirming system to mechanically prevent execution of an operation not included in a work procedure manual and prevent a confirmation mistake in a maintenance work is known. For example, a maintenance work confirming system to confirm a work in a maintenance work of a client system includes a host system and a maintenance work confirmation tool. The host system stores work instructions, performs analysis by using a content item of the work instructions as a keyword at the time of download to the maintenance work confirmation tool, and generates an input table showing resources necessary for the work and an operation level to a file (read/write/generation) on the basis of an analysis result. The maintenance work confirmation tool performs input by using the input table generated by the host system and monitors an environment check and a file operation of the client system.

However, under the present circumstances, a tool for automating works in a server is not so widespread for various reasons. Particularly, in a mission-critical server used in a socially-important system, the tool for automating works is not so widespread. The following are three reasons for this.

A first reason is that corporate users that operate a mission-critical server are not satisfied by simply executing a procedure automatically and desire to confirm an execution result of each operation.

For example, systems in financial institutions, transport facilities, communication companies, gas companies, and electric companies play a socially-important role. Thus, if some problems occur as a result of a work in a mission-critical server that plays a socially-important role, the entire society can be seriously affected. Moreover, the possibility of occurrence of a problem caused by inappropriate automation of works due to an oversight of a slight difference in environment is not zero.

Therefore, typical corporate users that operate a mission-critical server do not desire automatic execution of an entire procedure including a plurality of works. In many cases, the corporate users that operate a mission-critical server visually confirm an execution result of each work and execute a next work after determining that no problem occurs so that they can immediately deal with a problem when the problem does occur. For example, a maintenance worker performs a work to display a resetting value of an immediately preceding work, content of a file supposed to have been generated or changed in the immediately preceding work, and a value of an environment variable supposed to have been changed in the immediately preceding work on a screen, and confirms a result of the work by viewing the screen.

Thus, in automatic execution of a simple procedure, such as automatic reproducing of a macro, requirements of the corporate users that operate a mission-critical server are not satisfied.

A second reason is that an existing automating tool is incapable of adequately responding to a request for proving that an unnecessary or invalid work has not been performed.

For example, in the visual confirmation described above in the first reason, it is confirmed that an unnecessary or invalid work has not been performed in addition to a necessary work that has been properly executed. In order to prove that an unnecessary or invalid work has not been performed, an operation record (i.e., an operation log) is typically used.

However, when a maintenance worker performs a work under a super-user authority (also called an administrator authority) in a maintenance work of a server, the maintenance worker can easily tamper with a work record. Thus, the maintenance work may be requested to be performed by the maintenance worker under presence of another person, such as an administration supervisor, in order to prove that the maintenance worker does not tamper with a work record. That is, two people may be necessary for a maintenance work of a single server.

Simply automating works does not prevent tampering of a work record, and the necessity of presence of an administration supervisor or the like is not eliminated.

A third reason is that many works in a server are not suitable for automatic operation, e.g., reboot of the server.

For example, an entire system is backed up before changing the system operating in a server. Then, the server is rebooted after the backup in an ordinary case. However, complete automation of a procedure including reboot is not so general.

For example, in a work automating tool in a PC for a general user, a message window to ask a user whether reboot can be performed is often displayed when reboot is necessary. One of the reasons for this is that many users do not want automatic reboot of the computer regardless of the user's intention.

As for a server, too, it is not preferable that an important work such as reboot is executed in a completely automatic manner at timing unrelated to the intention of a maintenance worker. Thus, the automating tool may be avoided in a maintenance work of a server for the reason that a work unsuitable for simple automation, such as reboot, is included (e.g., see Japanese Laid-open Patent Publication Nos. 2006-119848 and 2008-21125).

### BRIEF DESCRIPTION OF DRAWINGS

FIG. 1 is a flowchart illustrating control in a first embodiment of the present invention;

FIG. 2 illustrates a configuration of a system in a second embodiment;

FIG. 3 is a flowchart illustrating an operation in the system illustrated in FIG. 2;

FIG. 4 is a flowchart of a process executed by a work target server in the second embodiment;

FIG. 5 illustrates the types of unordered works in the second embodiment;

FIG. 6 illustrates an example of a work procedure manual edit screen in the second embodiment;

FIG. 7 illustrates an example of a work adding screen in the second embodiment;

FIG. 8 illustrates an example of a formula edit screen in the second embodiment;

FIG. 9 illustrates an example of a work procedure manual in the second embodiment;

FIG. 10A illustrates an example of a command line interface of a work target server in the second embodiment;

FIG. 10B illustrates a continuation of FIG. 10A;

FIG. 11 is a timing chart specifically illustrating part of FIG. 10A;

FIG. 12 illustrates an example of a work record confirmation screen in the second embodiment;

FIG. 13 illustrates a configuration of a computer; and

FIGS. 14A and 14B illustrate configurations of systems according to modifications of the second embodiment.

### SUMMARY

According to an aspect of the embodiment, a computer-readable recording medium stores a control program, and the control program causes the computer to execute a process that includes:

an obtaining procedure for obtaining work procedure manual information about a plurality of ordered works and one or more unordered works associated with a range of a predetermined order;

an input procedure for receiving an input to provide instructions to execute a first work;

a recognizing procedure for recognizing whether the first work matches a second work that is initially-ordered in unexecuted ordered works among the plurality of ordered works or a third work associated with a range including the order of the second work among the one or more unordered works; and

a control procedure for allowing execution of the first work if the first work matches the second work or the third work and denying execution of the first work if the first work does not match any of the second and third works.

The objects and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

Automation of works in a server, particularly in a mission-critical server, has some propensity for interference of diffusion. However, automation of manual works is effective to increase efficiency. An automating technique in view of a characteristic of the mission-critical server will contribute to an increase in efficiency of works in the mission-critical server.

Accordingly, this embodiment provides a technique to achieve both allowing a worker to execute a manual work as necessary and insuring that works have been appropriately executed in an appropriate order.

In this embodiment, a control program is provided. The control program causes a computer to execute an obtaining step, an input step, a recognizing step, and a control step.

The obtaining step is a step of obtaining work procedure manual information about a plurality of ordered works and one or more unordered works associated with a range of a predetermined order.

The input step is a step of receiving an input to provide instructions to execute a first work.

The recognizing step is a step of recognizing whether the first work matches a second work or a third work, the second work being initially-ordered in unexecuted ordered works among the plurality of ordered works, the third work being associated with a range including the order of the second work among the one or more unordered works.

The control step is a step of allowing execution of the first work if the first work matches the second work or the third work and denying execution of the first work if the first work does not match any of the second and third works.

According to another technique disclosed, an information processing system is provided. The information processing system includes capturing means, first generating means, first input means, and adding means.

The capturing means captures content of a plurality of works executed by a first server, together with an execution order.

The first generating means generates work procedure manual information that associates the plurality of works as a plurality of ordered works on the basis of a result of capturing by the capturing means.

The first input means receives a first input that associates a range of order and a work.

The adding means adds the work associated in the first input received by the first input means to the work procedure manual information generated by the first generating means by associating the work as an unordered work with the range.

The information processing system further includes a second server that obtains the work procedure manual information updated by the adding means. The second server includes second input means, recognizing means, and control means.

The second input means receives a second input to provide instructions to execute a first work.

The recognizing means recognizes whether the first work matches a second work that is initially-ordered in unexecuted ordered works among the plurality of ordered works, or a third work that is the unordered work and that is associated with a range including the order of the second work with reference to the obtained work procedure manual information.

The control means allows execution of the first work if the first work matches the second work or the third work and denies execution of the first work if the first work does not match any of the second and third works.

According to the disclosed technique, an input from a worker or the like is allowed. On the other hand, ordered works are not executed in an inappropriate order inconsistent with work procedure manual information, and a work not defined in the work procedure manual information is not executed. Accordingly, appropriate execution of the works in an appropriate order can be ensured.

Hereinafter, embodiments of the present invention are described in detail with reference to the drawings.

### First Embodiment

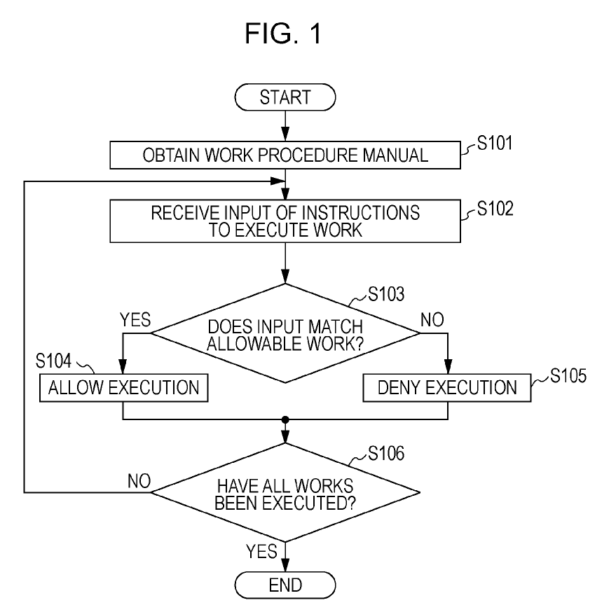

FIG. 1 is a flowchart illustrating control in a first embodiment of the present invention. In the first embodiment, a mission-critical server (not illustrated) executes the process illustrated in FIG. 1. FIG. 1 illustrates control when works are executed in the mission-critical server, and thus the mission-critical server is hereinafter called “work target server”.

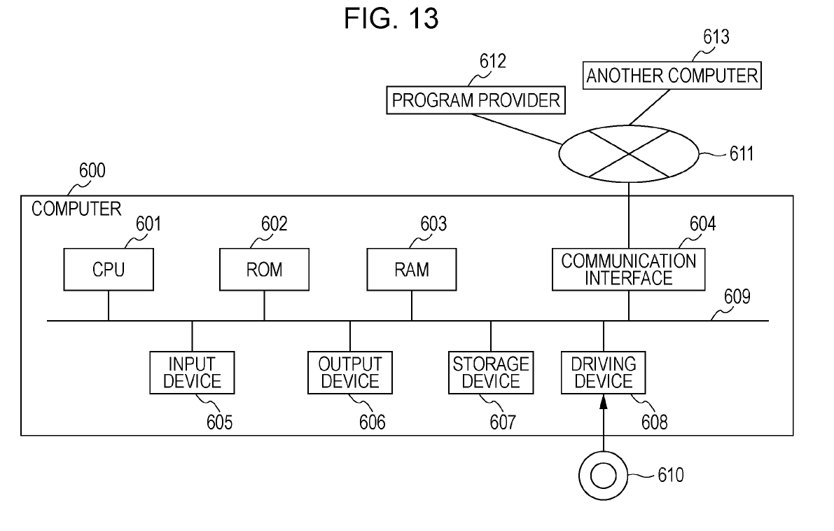

The work target server may have a configuration of a computer 600 described below with reference to FIG. 13, for example. In that case, a CPU 601 illustrated in FIG. 13 executes a program of the process illustrated in FIG. 1.

In step S101, the work target server obtains a work procedure manual and stores it in a storage device. The storage device may be a volatile memory such as a RAM (Random Access Memory), a nonvolatile memory such as a hard disk device, or a combination of the volatile and nonvolatile memories.

An arbitrary obtaining method is used in step S101. For example, the work target server may receive the work procedure manual from another computer via a network. Alternatively, the work procedure manual may be stored in advance in a computer-readable portable storage medium. Then, the storage medium may be set in a driving device for the storage medium included in the work target server, and the work target server may read the work procedure manual from the storage medium.

In the first embodiment, the “work procedure manual” is information about a plurality of ordered works and one or more unordered works. The respective unordered works are associated with a range of a predetermined order and are allowed to be executed in the associated range.

The respective works, i.e., each of the ordered works and the unordered works are executed by the work target server. For example, the ordered works may be a series of maintenance works that should be executed in a proper order, whereas the unordered works may be works to confirm results of the respective maintenance works.

In the first embodiment, the respective works are represented by command character strings input via a command line interface. Thus, the work procedure manual includes command character strings representing the plurality of ordered works and one or more unordered works.

After obtaining the work procedure manual in step S101, the work target server repeats the process from step S102 to step S106.

In step S102, the work target server receives an input to provide instructions to execute a work. The input to provide instructions to execute a work is a command character string that is input from a worker via the command line interface, for example. Alternatively, when the command line interface displays a candidate command to be executed in a prompt, the input in step S102 may be a specific key input to select whether the displayed candidate is to be executed or not.

In step S103, the work target server recognizes whether the input received in step S102 matches an allowable work. If the input matches the allowable work, the process proceeds to step S104. If the input does not match the allowable work, the process proceeds to step S105.

Here, the allowable work is a work applying to the following (1) or (2).

(1) An initially-ordered work in unexecuted works among the plurality of ordered works shown in the work procedure manual. The work applying to (1) is only one.

(2) A work associated with a range including the order of the work applying to (1) among one or more unordered works shown in the work procedure manual. The work applying to (2) may not exist, or one or more works may exist.

In step S103, the work target server recognizes whether the allowable work matches the input in step S102 on the basis of the work procedure manual and a history indicating previously-executed works.

The work target server may execute the recognition in step S103 by sequentially comparing the input in step S102 with the respective ordered works and unordered works in the work procedure manual. Alternatively, the work target server may execute the recognition in step S103 by generating control information about all the works applying to the above-described (1) and (2) and by referring to the control information.

In the recognition in step S103, two works represented by two command character strings match each other in any of the following three cases.

(1) In the case where the two command character strings completely coincide with each other.

(2) In the case where at least one of the command character strings includes an argument expressed by an expression and where the two command character strings coincide with each other when compared with each other while the expression in the command character string replaced by a value of an evaluation result of the expression.

(3) In the case where the command character string input in step S102 matches a command character string defined with the use of a wild card in the work procedure manual.

After step S103, the work target server allows execution of the work specified by the input received in step S102 and executes the work in step S104. On the other hand, in step S105, the work target server denies execution of the work specified by the input received in step S102.

After step S104 or S105, the process proceeds to step S106. In step S106, the work target server determines whether all the works that should be executed have been completed.

That is, the work target server determines whether all the ordered works shown in the work procedure manual have been executed. If all the ordered works shown in the work procedure manual have been executed, the process illustrated in FIG. 1 ends. If an unexecuted ordered work remains, the process returns to step S102.

According to the above-described process illustrated in FIG. 1, the ordered works are sequentially executed in step S104 while the order of the ordered works is maintained. For example, assume that first and second ordered works have been executed and that a third ordered work and thereafter have not been executed. In this case, if an input to provide instructions to execute the first or fourth ordered work is received in step S102, the execution of the work is denied in step S105. Accordingly, it is ensured that the ordered works are executed in the right order.

If an input to provide instructions to execute an unordered work is received in step S102, execution of the unordered work is allowed only when the input is received at the timing consistent with the work procedure manual.

That is, in the first embodiment, the worker can arbitrarily determine whether an unordered work defined in the work procedure manual is to be executed or not. Also, when the work procedure manual includes an unordered work X associated with a range “from after the n-th ordered work to before the m-th ordered work” (n and m are integers satisfying 1≦n<m), a certain degree of freedom is given to the order of executing the unordered work X.

For example, an unordered work with no side-effect can be executed anytime without problem, and thus the unordered work may be associated with a range “from before the first ordered work to immediately before the last ordered work”.

Alternatively, the first embodiment may be modified so that it is determined in step S106 that the work procedure ends if all the ordered works have been executed and if an input to provide instructions to end the work procedure is expressly given. Then, it becomes possible to allow execution of an unordered work also after the last ordered work. For example, an unordered work with no side-effect may be associated with a range “from before the first ordered work to after the last ordered work”.

Therefore, in the first embodiment and the modification thereof, only if one or a plurality of unordered works are appropriately defined in the work procedure manual, can the unordered works be flexibly executed when a worker inputs instructions to execute the unordered works as necessary. That is, in the first embodiment, flexibility in terms of whether an unordered work is to be executed and flexibility in terms of the timing to execute the unordered work are ensured.

On the other hand, in the first embodiment, execution of an unordered work is not allowed at an inappropriate timing inconsistent with the work procedure manual, and also execution of a work not defined in the work procedure manual is not allowed. For example, if the worker gives an input to provide instructions to execute the above-described unordered work X to the work target server via the command line interface before the n-th ordered work or after the m-th ordered work, execution of the unordered work X is denied.

Thus, according to the first embodiment, flexibility is ensured and also appropriateness of the actually executed procedure is ensured. Since the work target server itself ensures the appropriateness of the procedure in the process illustrated in FIG. 1, the necessity of visual confirmation by someone to ensure the appropriateness of the procedure is eliminated in the first embodiment. Therefore, in the first embodiment, time and effort for ensuring that the works have been appropriately executed in an appropriate order are reduced compared to the related art.

### Second Embodiment

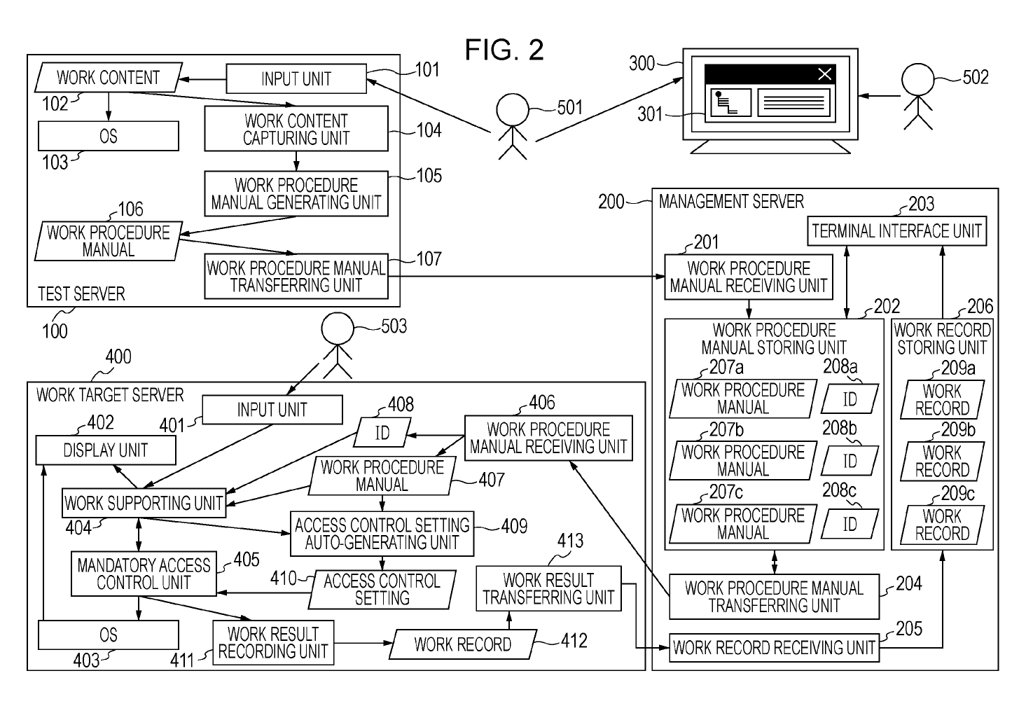

Next, a second embodiment is described with reference to FIGS. 2 to 14.

FIG. 2 illustrates a system configuration according to the second embodiment. The system illustrated in FIG. 2 includes four blocks mutually connected via a network (not illustrated): a test server 100; a management server 200; an operation terminal 300; and a work target server 400. FIG. 2 further illustrates a worker 501, an administrator 502, and a worker 503. The worker 501 and the worker 503 may be the same person or different persons.

The work target server 400 is a mission-critical server that provides a socially-important service. Thus, the work target server 400 executes only work procedures in which the appropriateness is ensured.

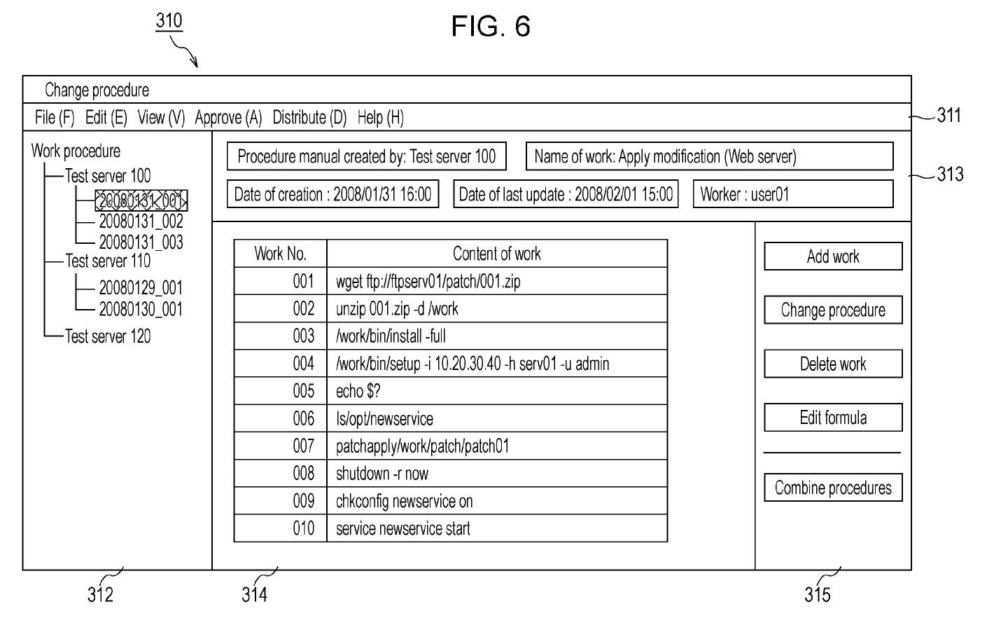

The test server 100 is an environment to test in advance a work procedure to be executed in the work target server 400 and to generate an appropriate work procedure manual 106. An example of the work procedure manual 106 is described below with reference to FIG. 6. The hardware and software configuration of the test server 100 are the same as those of the work target server 400 or may be a subset of the work target server 400.

The management server 200 receives, stores, and manages the work procedure manual 106 generated by the test server 100. The management server 200 accumulates and manages a plurality of work procedure manuals. FIG. 2 illustrates work procedure manuals 207a to 207c. For example, the work procedure manuals 207a and 207b are previously accumulated by the management server 200, whereas the work procedure manual 207c corresponds to the work procedure manual 106 that is newly generated by the test server 100 and that is newly received and stored by the management server 200.

In the second embodiment, the management server 200 is an independent server as a server environment dedicated for management that is separated from the test server 100 and the work target server 400.

The work procedure manuals 207a to 207c stored in the management server 200 are referred to and edited via the operation terminal 300. Although the details are described below, the management server 200 and the operation terminal 300 provide a function enabling the reference and edit.

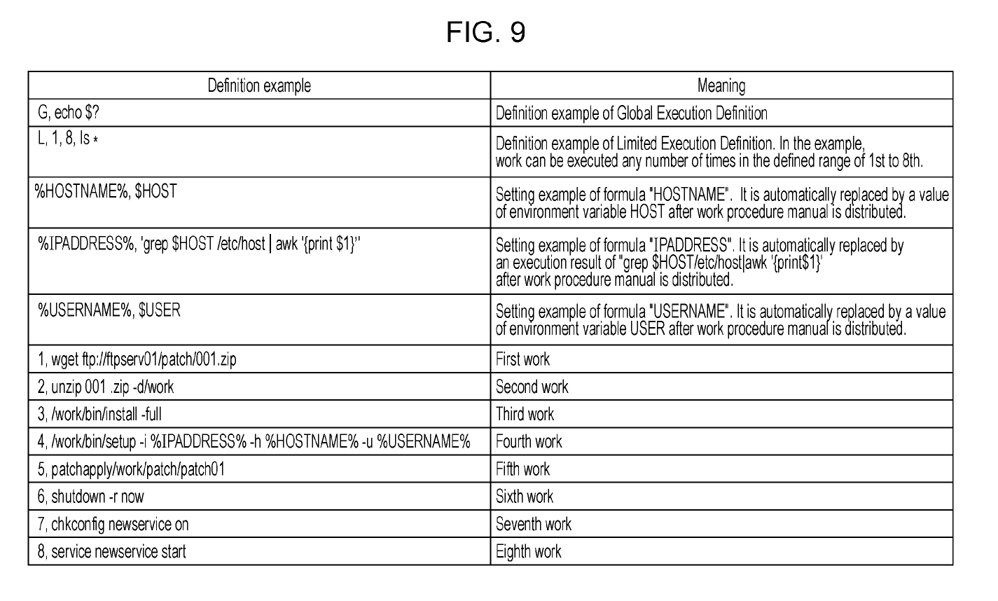

There are various types of edit, e.g., change, deletion, and addition of respective works, combining a plurality of work procedure manuals, approval of work procedure manuals, and definition of formulas. Examples of a screen 301 of the operation terminal 300 to perform various types of edit are described below with reference to FIGS. 6 to 8. Also, an example of the work procedure manual 207c that has been edited is described below with reference to FIG. 9.

The work procedure manuals 207a to 207c stored in the management server 200 are transmitted to the work target server 400 as necessary. For example, the management server 200 transmits the work procedure manual 207c to the work target server 400, so that the work target server 400 obtains the transmitted work procedure manual 207c as a work procedure manual 407.

The work target server 400 operates in accordance with the work procedure manual 407 on the basis of a process similar to that in the first embodiment, and records an operation result as a work record 412.

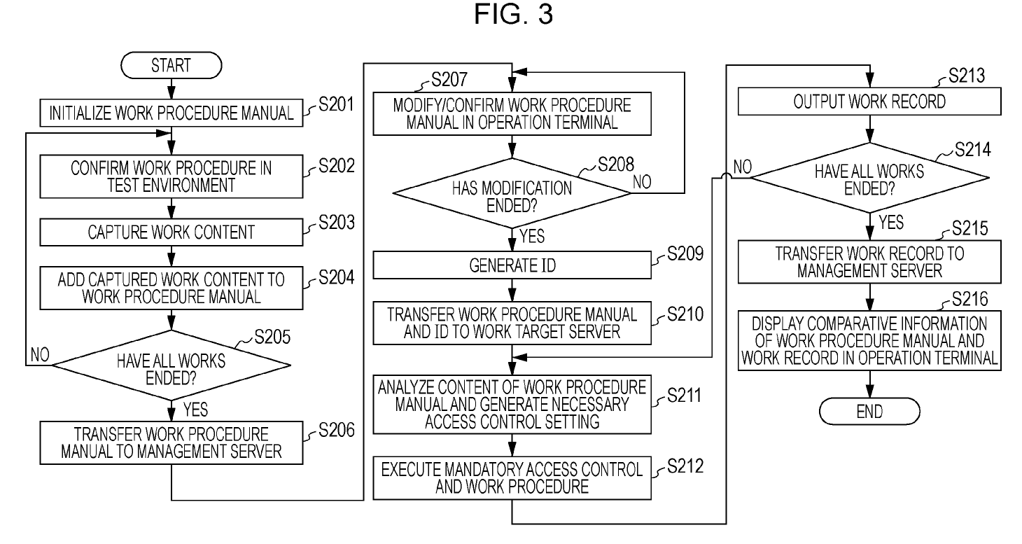

Specifically, the work target server 400 generates an access control setting 410 on the basis of the work procedure manual 407 and executes mandatory access control using the access control setting 410, thereby providing a work support function to the worker 503. The access control setting 410 is an example of the control information described above about step S103 in FIG. 1 in the first embodiment. Work support involving the mandatory access control is described below with reference to FIGS. 3, 4, and 10A to 11.

Hereinafter, “mandatory access control” means control to allow or deny execution of respective works. That is, “access” in “mandatory access control” in this embodiment means execution access to an executable file to realize a work.

Also, the work target server 400 transmits the work record 412 to the management server 200.

The management server 200 accumulates and manages the work record 412 received from the work target server 400. FIG. 2 illustrates a plurality of work records 209a to 209c. For example, the work records 209a and 209b are previously accumulated by the management server 200, whereas the work record 209c is newly received from the work target server 400.

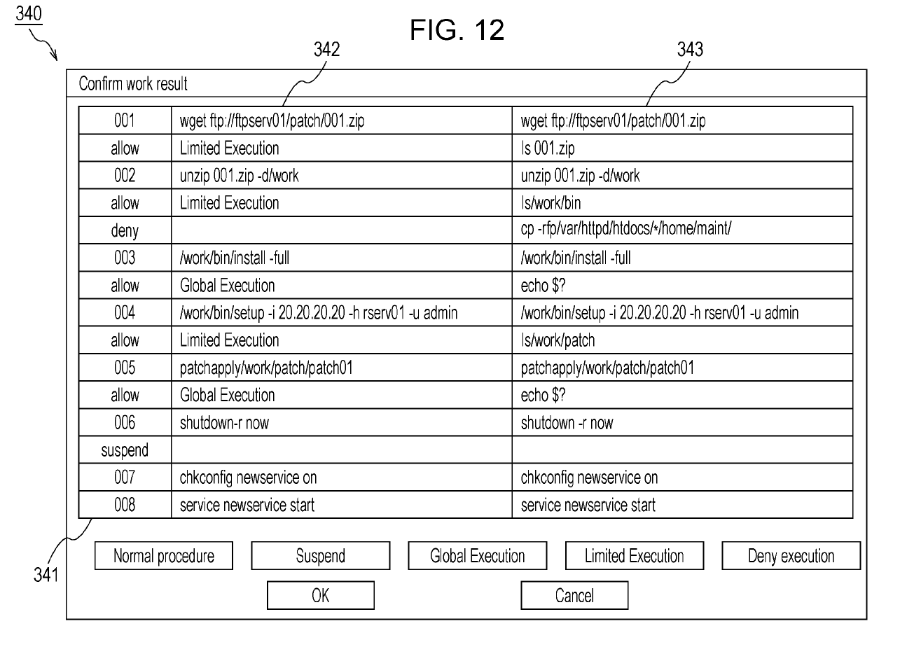

The management server 200 and the operation terminal 300 also provide a function to refer to the work records 209a to 209c via the operation terminal 300. The reference to the work records 209a to 209c is described below with reference to FIG. 12.

Hereinbefore, the overview of FIG. 2 has been described. Hereinafter, the details of FIG. 2 are described.

The test server 100 includes an input unit 101 to receive an input from the worker 501. The input unit 101 is realized by an input device, such as a keyboard and a pointing device, and a command line interface. Work content 102 represented by a command character string input by the worker 501 from the keyboard is transmitted to an OS (Operating System) 103 of the test server 100 via the input unit 101. The OS 103 executes a work in accordance with the work content 102.

Also, the test server 100 includes a work content capturing unit 104 to capture and collect the work content 102 by monitoring information transmitted from the input unit 101 to the OS 103. For example, the work content capturing unit 104 can be realized by using a known hook technique.

Alternatively, the work content capturing unit 104 may capture the work content 102 by referring to a command execution history that is updated every time the OS 103 executes a command. In any case, the work content capturing unit 104 functions as capturing means for capturing the content of a plurality of works executed in the test server 100 together with the execution order.

The test server 100 further includes a work procedure manual generating unit 105 and a work procedure manual transferring unit 107. When capturing the work content 102, the work content capturing unit 104 instructs the work procedure manual generating unit 105 to generate the work procedure manual 106 from the work content 102. The work procedure manual generating unit 105 generates the work procedure manual 106 in response to the instructions, and the work procedure manual transferring unit 107 transmits the generated work procedure manual 106 to the management server 200.

In this stage, the work procedure manual 106 includes a plurality of ordered works associate with an order, and does not include a definition of an unordered work. The work procedure manual generating unit 105 functions as first generating means for generating the work procedure manual 106 on the basis of a result of capturing by the work content capturing unit 104.

The management server 200 includes a work procedure manual receiving unit 201, a work procedure manual storing unit 202, a terminal interface unit 203, a work procedure manual transferring unit 204, a work record receiving unit 205, and a work record storing unit 206.

The work procedure manual receiving unit 201 receives a work procedure manual from the test server 100 and outputs it to the work procedure manual storing unit 202. The work procedure manual storing unit 202 accumulates the plurality of work procedure manuals 207a to 207c received from the work procedure manual receiving unit 201.

The terminal interface unit 203 provides a function enabling the worker 501 and the administrator 502 to refer to and edit the work procedure manuals 207a to 207c and to refer to the work records 209a to 209c via the screen 301 of the operation terminal 300. For example, the terminal interface unit 203 and the operation terminal 300 operate in the following manner (1) to (3).

(1) When the worker 501 or the administrator 502 wants to refer to the work procedure manual 207c via the screen 301, the operation terminal 300 transmits an ID (identifier) 208c of the work procedure manual 207c to the terminal interface unit 203.

Then, the terminal interface unit 203 transmits data necessary to display the content of the work procedure manual 207c on the screen 301 to the operation terminal 300, so that the operation terminal 300 displays the content of the work procedure manual 207c on the screen 301.

(2) When the operator 501 or the administrator 502 provides instructions to edit the work procedure 207c via the screen 301, the operation terminal 300 transmits the instructions to the terminal interface unit 203. The terminal interface unit 203 edits the work procedure manual 207c in the work procedure manual storing unit 202 in accordance with the received instructions.

That is, the operation terminal 300 and the terminal interface unit 203 function as first input means for receiving an input to edit the work procedure manual 207c. For example, when a received input is an input to associate a range of order with a work, the terminal interface unit 203 also functions as adding means for associating the work as an unordered work that is associated in the received input with the input range and adding the work to the work procedure manual 207c.

(3) When the administrator 502 wants to determine whether a work procedure has been correctly executed in accordance with the work procedure manual 207c, the operation terminal 300 transmits the ID 208c of the work procedure manual 207c to the terminal interface unit 203. Then, the terminal interface unit 203 transmits data necessary to display the content of the work procedure manual 207c and the work record 209c associated with the ID 208c on the screen 301 to the operation terminal 300.

The operation terminal 300 displays the content of the work procedure manual 207c and the work record 209c by comparing them in accordance with the received data, so that the administrator 502 can easily make a determination.

In order to realize the above-described operations (1) to (3), the operation terminal 300 may be provided with a dedicated application program to display the screen 301. Alternatively, when the terminal interface unit 203 functions as a web server to provide a web application, the operation terminal 300 can display the screen 301 by using a multi-purpose web browser.

The work procedure manual transferring unit 204 transmits the work procedure manual 207c and the ID 208c to the work procedure manual receiving unit 406 as necessary. The work record receiving unit 205 receives the work record 412 generated in the work target server 400 in association with the work procedure manual 207c and stores the work record 412 as the work record 209c in the work record storing unit 206.

The work target server 400 includes an input unit 401 to receive an input from the worker 503 and a display unit 402 to display a prompt and a message to the worker 503. Also, an OS 403 is installed in the work target server 400.

The input unit 401 is realized by an input device, such as a keyboard and a pointing device, and a command line interface, for example. The display unit 402 is realized by a display device, such as a liquid crystal display, and a command line interface.

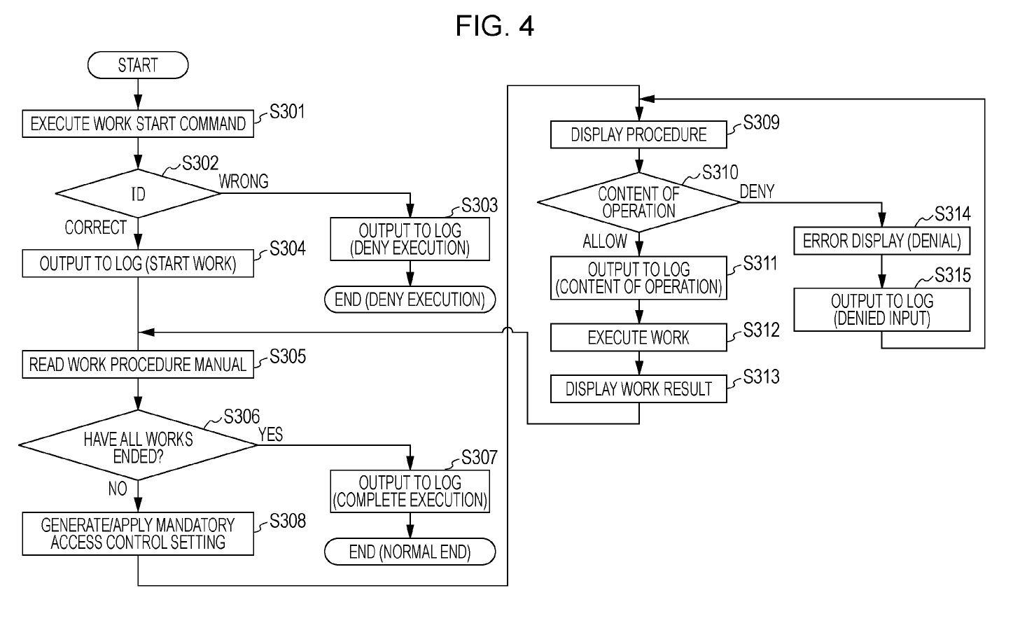

The work target server 400 further includes a work supporting unit 404, a mandatory access control unit 405, a work procedure manual receiving unit 406, an access control setting auto-generating unit 409, a work result recording unit 411, and a work result transferring unit 413. Those units operate in the manner described below, more specifically, in the manner illustrated in FIG. 4.

The work supporting unit 404 supports the worker 503 by serving as a mediator between a user interface including the input unit 401 and the display unit 402 and mandatory access control including the access control setting auto-generating unit 409 and the mandatory access control unit 405. The input unit 401 and the work supporting unit 404 function as second input means for receiving an input to provide instructions to execute a first operation.

The access control setting auto-generating unit 409 generates the access control setting 410 on the basis of the work procedure manual 407 received by the work procedure manual receiving unit 406. Generation of the access control setting 410 is repeatedly performed in a dynamic manner. The mandatory access control unit 405 executes mandatory access control on the basis of the access control setting 410.

A work allowed to be executed by the mandatory access control unit 405 is executed by the OS 403, and the display unit 402 displays an execution result.

In this way, the access control setting auto-generating unit 409 and the mandatory access control unit 405 function as recognizing means for recognizing whether a work requested to be executed by the input received via the input unit 401 and the work supporting unit 404 matches an allowable work. The allowable work is a second work that is initially-ordered in unexecuted ordered works or a third work that is an unordered work associated with a range including the order of the second work.

Also, the mandatory access control unit 405 functions as control means for allowing execution of the first work if the first work matches the second work or the third work and denying execution of the first work if the first work does not match any of the second work and the third work.

The work result recording unit 411 generates the work record 412 that associates all the instructions received by the work supporting unit 404 from the input unit 401 with a result of allowance or denial of execution by the mandatory access control unit 405.

The work result transferring unit 413 transmits the work record 412 to the management server 200 after a series of works included in the work procedure manual 407 have been completed.

The work record 412 is a kind of audit log. The work target server 400 protects the work record 412 against the risk of tampering by using a known technique for preventing tampering of an audit log. For example, a write authority to the work record 412 is given only to the work result recording unit 411, and a read authority of the work record 412 is given only to the work supporting unit 404 and the work result transferring unit 413, whereby the work target server 400 can protect the work record 412.

Also, the management server 200 protects the received work records 209a to 209c by using the same tampering preventing technique. That is, in the management server 200, only the work record receiving unit 205 has a write authority to the work record storing unit 206 storing the work records 209a to 209c. Also, only the terminal interface unit 203 has a read authority of the work records 209a to 209c from the work record storing unit 206. Therefore, the work records 209a to 209c referred to via the operation terminal 300 are correct records that are not tampered.

Next, an outline of operations in the system illustrated in FIG. 2 is described with reference to FIG. 3. FIG. 3 is a flowchart illustrating the operations in the system illustrated in FIG. 2.

In step S201, the work procedure manual generating unit 105 initializes the work procedure manual 106 at the timing when the input unit 101 receives a specific input to provide instructions to start generating the work procedure manual 106 from the worker 501. Specifically, the work procedure manual generating unit 105 newly generates an empty work procedure manual 106, collects meta-information about the work procedure manual 106 described below with reference to FIG. 6, and writes the meta-information in the work procedure manual 106.

The subsequent steps S202 to S205 form a repetition loop. One loop of steps S202 to S205 corresponds to one work. In the process from step S201 to step S205, the work procedure manual 106 is automatically generated only by the worker 501's confirming the work procedure to be executed in the work target server 400 in the test server 100 in advance.

In step S202, the work procedure is confirmed in the test server 100, which is a test environment. Specifically, the input unit 101 receives the work content 102 from the worker 501 and outputs the work content 102 to the OS 103. In this embodiment, the work content 102 is represented by a command character string. The command character string may include an argument (also called option) and may include a pipe or a redirection. The OS 103 executes a work as usual in accordance with the work content 102.

Then, in step S203, the work content capturing unit 104 that constantly monitors the input to the OS 103 captures the work content 102 and stores it in a RAM of the test server 100. For example, the work content capturing unit 104 can capture the work content 102 input to the OS 103 by hooking it.

In step S204, the work content capturing unit 104 instructs the work procedure manual generating unit 105 to add the captured work content 102 to the work procedure manual 106. The work procedure manual generating unit 105 adds the work content 102 to the work procedure manual 106 with reference to the work content 102 stored in the RAM.

For example, in i-th execution of step S204 (i is an integer of 1 or more), the work procedure manual generating unit 105 adds a set of integer i indicating the execution order of the work and the command character string representing the work at the i-th execution to the work procedure manual 106. That is, executing step S204 i times causes i ordered works to be recorded in the work procedure manual 106.

Then, in step S205, the work content capturing unit 104 determines whether a series of works constituting the work procedure have ended. For example, if the input unit 101 receives a specific input indicating end of the works from the worker 501, the work content capturing unit 104 determines that the works have ended, and the process proceeds to step S206. If the input unit 101 does not receive the specific input indicating end of the works, the process returns to step S202, where the input unit 101 receives a command character string representing the next work.

The specific input indicating end of the works may be classified into two or more types, one of which may be a command character string to reboot the test server 100.

In step S206, the work procedure manual transferring unit 107 transmits the work procedure manual 106 to the management server 200, and the work procedure manual receiving unit 201 receives the work procedure manual 106 and stores it as the work procedure manual 207a in the work procedure manual storing unit 202, for example.

The subsequent steps S207 to S208 form a repetition loop.

In step S207, the worker 501 and the administrator 502 appropriately modify and confirm the work procedure manuals 207a to 207c via the screen 301 of the operation terminal 300. An editing function to modify the work procedure manuals 207a to 207c and a referring function to confirm the work procedure manuals 207a to 207c are provided by the terminal interface unit 203 and the operation terminal 300, as described above.

More specifically, the operation terminal 300 and the terminal interface unit 203 receive the following instructions (1) to (9) from the worker 501 as necessary. Then, the terminal interface unit 203 appropriately edits the work procedure manuals 207a to 207c in the work procedure manual storing unit 202 in response to the received instructions. In the following example, the work procedure manual 207c is eventually generated, and the works eventually included in the work procedure manual 207c include two types of works: ordered works and unordered works.

(1) Instructions to combine the work procedure manual 207a with another work procedure manual 207b and stores the combined work procedure manual as a new work procedure manual 207c.

(2) Instructions to add a work to the work procedure manual 207c.

(3) Instructions to delete a work from the work procedure manual 207c.

(4) Instructions to add definition of a formula to the work procedure manual 207c.

(5) Instructions to change the content of a work in the work procedure manual 207c by changing a command name or an argument in a command.

(6) Instructions to change an ordered work to an unordered work or instructions to change an unordered work to an ordered work.

(7) Instructions to associate an unordered work with a range of order.

(8) Instructions to change order of the works in the work procedure manual 207c.

(9) Instructions to specify the work target server 400 as a distribution destination of the work procedure manual 207c.

The above-described instructions (1) to (9) may be given by the administrator 502. Contrary to the instructions (1), instructions to divide a work procedure manual into a plurality of sections may be applied in an embodiment.

Also, the operation terminal 300 and the terminal interface unit 203 receive an input to approve the appropriateness of the work procedure manual 207c that has been edited from the administrator 502. Then, the terminal interface unit 203 changes the status of the work procedure manual 207c in the work procedure manual storing unit 202 to “approved”. For example, the terminal interface unit 203 may write data indicating “approved” in the work procedure manual 207c, or may set a value of a flag provided outside the work procedure manual 207c to a value indicating “approved”. An arbitrary method for indicating “approved” or “unapproved” may be used in accordance with an embodiment.

In step S208, the operation terminal 300 or the terminal interface unit 203 determines whether modification of the work procedure manual 207c has ended or not. For example, if an input to approve the appropriateness of the work procedure manual 207c is received from the administrator 502, the terminal interface unit 203 may determine that modification of the work procedure manual 207c has ended.

After modification of the work procedure manual 207c has ended, the process proceeds to step S209. If modification of the work procedure manual 207c has not ended, the process returns to step S207.

In step S209, the terminal interface unit 203 generates a unique ID 208c in the management server 200 and stores the ID 208c in the work procedure manual storing unit 202 by associating it with the work procedure manual 207c.

In step S210, the work procedure manual transferring unit 204 transfers a set of the work procedure manual 207c and the ID 208c to the work target server 400. The transferred work procedure manual 207c and ID 208c are received as the work procedure manual 407 and the ID 408 by the work procedure manual receiving unit 406 in the work target server 400. The work procedure manual receiving unit 406 outputs the work procedure manual 407 and the ID 408 to the work supporting unit 404.

Steps S211 to S214 form a repetition loop. Steps S211 to 5214 show an outline, and the details thereof are described below with reference to FIG. 4.

In step S211, the work supporting unit 404 instructs the access control setting auto-generating unit 409 to generate the access control setting 410 as necessary on the basis of an input received by the input unit 401. Then, the access control setting auto-generating unit 409 analyzes the content of the work procedure manual 407 and generates necessary access control setting 410 on the basis of an analysis result.

In step S212, the mandatory access control unit 405 executes mandatory access control on the basis of the input from the work supporting unit 404 and the access control setting 410. That is, the mandatory access control unit 405 determines whether execution of the work specified via the work supporting unit 404 is to be allowed or not on the basis of the access control setting 410.

When allowing execution of the work, the mandatory access control unit 405 outputs the work content to the OS 403. As a result, the work is executed via the OS 403, and various work responses indicating an execution result are displayed in the display unit 402.

Then, in step S213, the mandatory access control unit 405 notifies the work result recording unit 411 of a determination result of the mandatory access control executed in step S212. The work result recording unit 411 outputs the result obtained from the mandatory access control unit 405 to the work record 412. The work record 412 includes a command character string representing the work specified via the input unit 401 and the work supporting unit 404 and the determination result in step S212, for example.

In step S214, the work supporting unit 404 determines whether all the ordered works defined in the work procedure manual 407 have ended or not. If all the ordered works have ended, the process proceeds to step S215. If an unprocessed ordered work remains, the process returns to step S211.

In step S215, the work result transferring unit 413 transfers the work record 412 to the management server 200. The work record receiving unit 205 of the management server 200 receives the work record 412 and stores it as the work record 209c in the work record storing unit 206. If transfer to the management server 200 has been successfully done, the work result transferring unit 413 may notify the work result recording unit 411 of the success of the transfer, and the work result recording unit 411 may erase the work record 412.

In step S216, the terminal interface unit 203 receives instructions from the administrator 502 from the operation terminal 300 via the screen 301. On the basis of the received instructions, the terminal interface unit 203 transmits, to the operation terminal 300, data necessary to display comparative information of the work record 209c and the work procedure manual 207c associated with the same ID 208c on the screen 301. The management server 200 displays the comparative information of the work procedure manual 207c and the work record 209c on the screen 301 on the basis of the received data. Accordingly, the administrator 502 can easily determine that the works have been appropriately executed in the work target server 400 on the basis of the displayed content.

FIG. 4 is a flowchart of a process executed by the work target server in the second embodiment. As described above, FIG. 4 illustrates the details of steps S211 to S214 in FIG. 3.

In step S301, the work supporting unit 404 receives a specific command to start a work in accordance with the work procedure manual 407 via the input unit 401, and executes the received command. Hereinafter, a description is given under the assumption that the command in step S301 has a name “startmaintenance” and requires the ID 408 corresponding to the work procedure manual 407 to be referred to as an argument.

Furthermore, in step S301, the work supporting unit 404 obtains an authority necessary for the subsequent steps. For example, the work supporting unit 404 obtains a super user authority so that works executed by the OS 403 via the work supporting unit 404 and the mandatory access control unit 405 are executed under the super user authority.

In step S302, the work supporting unit 404 determines whether the argument specified by the “startmaintenance” command in step S301 is a correct ID 408 or not.

For example, the work procedure manual 407 is associated with the ID 408 and is stored in a predetermined directory in the hard disk device of the work target server 400. In this case, if the work procedure manual 407 associated with the specified argument exists in the predetermined directory, the work supporting unit 404 determines that the specified argument is the correct ID 408 and specifies the work procedure manual 407 as the work procedure manual that should be read.

If a wrong value different from the ID 408 that is received together with the work procedure manual 407 by the work procedure manual receiving unit 406 is specified as an argument in step S301, the process proceeds to step S303. On the other hand, if the correct ID 408 is specified as an argument in step S301, the process proceeds to step S304.

In step S303, the work supporting unit 404 notifies the mandatory access control unit 405 that a wrong ID is specified together with the value of the ID 408. On the basis of the notification from the work supporting unit 404, the mandatory access control unit 405 instructs the work result recording unit 411 to output information indicating that execution of the “startmaintenance” command is denied to the work record 412, i.e., to a log.

Then, the work result recording unit 411 outputs information indicating that execution of the “startmaintenance” command is denied to the work record 412. Also, the work supporting unit 404 ends the use of the authority obtained in step S301. Accordingly, the process in FIG. 4 ends.

On the other hand, if the correct ID 408 is specified, step S304 and thereafter is executed.

In step S304, the work supporting unit 404 notifies the mandatory access control unit 405 that the correct ID 408 has been specified together with the value of the ID 408. On the basis of the notification from the work supporting unit 404, the mandatory access control unit 405 instructs the work result recording unit 411 to output information indicating that a work starts in accordance with the work procedure manual 407 by the “startmaintenance” command to the work record 412, i.e., to a log. Then, the work result recording unit 411 outputs information indicating start of the work to the work record 412 in response to the instructions.

Also, in step S304, the work supporting unit 404 recognizes the number of ordered works that have been executed and sets a value of a counter variable k indicating the number of executed ordered works to the recognized value.

That is, the work supporting unit 404 determines whether there exists the work record 412 corresponding to the ID 408 determined to be correct in step S302. If the work record 412 corresponding to the ID 408 does not exist, execution of the work procedure based on the work procedure manual 407 has not been executed before, so that the work supporting unit 404 recognizes that k=0.

On the other hand, if there exists the work record 412 corresponding to the ID 408 determined to be correct in step S302, the work supporting unit 404 refers to the work record 412. If necessary, the work supporting unit 404 refers also to the work procedure manual 407 in accordance with the form of the work record 412 and compares the work procedure manual 407 with the work record 412. As a result, the work supporting unit 404 recognizes the ordered work(s) defined in the work procedure manual 407 that has (have) been previously executed on the basis of the work record 412.

For example, assume that a work to reboot the OS 403 is included in the third work in the work procedure manual 407 including ten ordered works. In this case, if the process illustrated in FIG. 4 is executed again after reboot, the work record 412 showing an execution history of the first to third ordered works is found, so that the work supporting unit 404 recognizes that k=3 in step S304.

Also, the work supporting unit 404 executes a formula replacing process described below in step S304.

Then, in step S305, the work supporting unit 404 reads the work procedure manual 407 corresponding to the ID 408. In step S306, the mandatory access control unit 405 determines whether all the ordered works defined in the work procedure manual 407 have ended or not.

For example, assume that N ordered works are defined in the work procedure manual 407 (N is an integer of 2 or more). In this case, when N=k, all the ordered works have been ended and thus the process proceeds to step S307. When N>k, there is an unexecuted ordered work and thus the process proceeds to step S308.

In step S307, the mandatory access control unit 405 instructs the work result recording unit 411 to output information indicating that execution of the work procedure according to the work procedure manual 407 has been completed to the work record 412, i.e., to a log. In response to the instructions, the work result recording unit 411 outputs information indicating completion of the execution of the work procedure to the work record 412. Also, the work supporting unit 404 ends the use of the authority obtained in step S301. Then, the process illustrated in FIG. 4 normally ends.

On the other hand, if an unexecuted ordered work remains, the access control setting auto-generating unit 409 generates the access control setting 410 in step S308. The access control setting 410 generates in step S308 is applied in step S310. The access control setting 410 is information indicating works that can be immediately executed, specifically, information indicating all the works that satisfy the following condition (1) or (2).

(1) Among unexecuted ordered works in the N ordered works included in the work procedure manual 407, the initially-ordered work, i.e., the (k+1)-th ordered work.

(2) Among unordered works included in the work procedure manual 407, an unordered work associated with a range including the order of (k+1)-th.

Then, in step S309, the work supporting unit 404 allows the display unit 402 to display the (k+1)-th ordered work with reference to the work procedure manual 407. According to a default procedure in this embodiment, the work satisfying (1) among the works that can be immediately executed now is executed. In step S309, the display unit 402 displays the default procedure, so that the worker 503 recognizes the default procedure.

Then, the worker 503 who sees the display unit 402 performs an input operation via the input unit 401. The input unit 401 may receive an input to provide instructions to execute the (k+1)-th ordered work displayed in step S309, or may receive an input to provide instructions to execute another work.

Then, in step S310, the input unit 401 notifies the work supporting unit 404 of the content of the input received from the worker 503. The work supporting unit 404 outputs the input received from the input unit 401 to the mandatory access control unit 405 and provides instructions to execute mandatory access control by applying the access control setting 410 generated in step S308.

The mandatory access control unit 405 that has received the instructions determines whether the input from the work supporting unit 404, i.e., the content of operation performed by the worker 503, matches the work that can be immediately executed now by the access control setting 410. If the input matches, the process proceeds to step S311 to allow execution of the work. If the input does not match, the process proceeds to step S314 to deny execution of the work.

In step S311, the mandatory access control unit 405 instructs the work result recording unit 411 to output information indicating that execution of the input work is allowed to the work record 412 together with the input content. In response to the instructions, the work result recording unit 411 outputs the work allowed to be executed to the work record 412, i.e., to a log.

For example, the work result recording unit 411 adds the command character string input in step S309 to the work record 412 together with the data indicating the allowance of execution of the command. Also, the work result recording unit 411 may further record the content of the following (1) to (4) in the work record 412.

(1) Type of work: ordered work or unordered work

(2) Date and time of execution of the work

(3) Associated order in the case of an ordered work

(4) Associated range in the case of an unordered work

Then, in step S312, the mandatory access control unit 405 instructs the OS 403 to execute the work indicated by the operation performed by the worker 503 in step S309. The OS 403 executes the work in accordance with the instructions from the mandatory access control unit 405. The mandatory access control unit 405 increments the value of the counter variable k by 1, the value indicating the number of ordered works that have been executed.

In step S313, the OS 403 allows the display unit 402 to display the result of the work. As a result, the worker 503 can see the result of the input operation to the input unit 401 in the display unit 402. After step S313, the process returns to step S305.

On the other hand, if an operation to provide instructions to execute a work that is not allowed to be executed is performed in step S309, the mandatory access control unit 405 notifies the work supporting unit 404 of denial of execution of the work in step S314. Then, the work supporting unit 404 instructs the display unit 402 to perform error display indicating that the input is denied. In response to the instructions, the display unit 402 performs error display.

In step S315, the mandatory access control unit 405 instructs the work result recording unit 411 to record denial of execution of the work indicated by the operation performed by the worker 503 in step S309 in the work record 412. In response to the instructions, the work result recording unit 411 adds the denied input to the work record 412 together with the data indicating the denial of execution.

When execution of the work specified in step S309 is denied, no change occurs in the value of the counter variable k indicating the number of ordered works that have been executed. Thus, there is no need to update the access control setting 410. Thus, the process returns to step S309 after step S315.

Next, the specific example of the work procedure manual 407 and the access control setting 410 in the second embodiment is further described in detail with reference to examples of the screen and a timing chart.

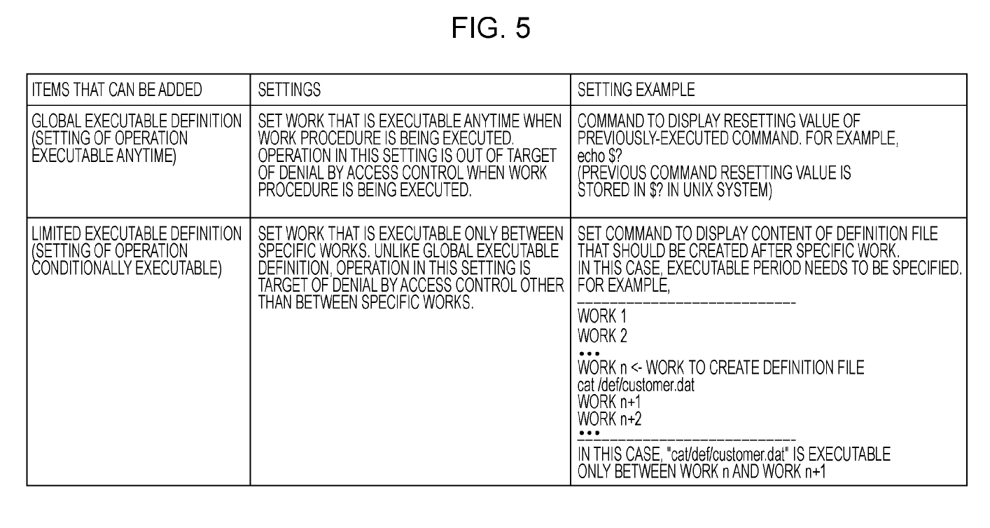

FIG. 5 illustrates the types of unordered work in the second embodiment.

In the second embodiment, two types of unordered works named as “global executable definition” and “limited executable definition” can be added to the work procedure manuals 207a to 207c.

The global executable definition is an unordered work that can be executed and is allowed by the mandatory access control unit 405 to be executed anytime when the work procedure defined in the work procedure manual is being executed. That is, an operation to provide instructions to execute an unordered work set as the global executable definition is not a target of denial by the mandatory access control when the work procedure is being executed.

In other words, in a work procedure manual including a plurality of ordered works, an unordered work set as the global executable definition is associated with a global range from immediately before or after the first order of ordered works to immediately before or after the last order of the ordered works.

In this embodiment, the condition “anytime when the work procedure is being executed” is interpreted as “from before the first ordered work is executed to before the last ordered work is executed”. Thus, in this embodiment, an unordered work set as the global executable definition is associated with a range from immediately before the first order to immediately before the last order. In accordance with an embodiment, definition of the global range corresponding to the global executable definition can be appropriately determined. For example, an embodiment in which the global range is defined as “from immediately after the first order to immediately after the last order” can be applied.

An example of an unordered work suitable for being set as the global executable definition is a command to determine whether the previously-executed command has normally ended by displaying a resetting value of the previously-executed command. A specific example is a command “echo$?”. In a UNIX system (UNIX is a registered trademark), a resetting value of the previous command is stored in a variable “$?”, and “echo” is a command to output an argument to standard output.

On the other hand, there exists a work of which an execution order should preferably be limited to some extent and an unordered work of which the execution order needs to be limited to some extent. Such an unordered work is defined by a limited executable definition that is executable only in the range defined by the order of specific two ordered works. An unordered work set as the limited executable definition is, unlike an unordered work set as the global executable definition, a target of denial by the mandatory access control unit 405 outside the defined range.

An example of an unordered work suitable for being set as the limited executable definition is a command to display content of a definition file that should be generated after a specific ordered work.

For example, assume that the n-th ordered work is a work to generate a definition file “/def/customer.dat”. Also, assume that the (n+1)-th ordered work is a work using the definition file “/def/customer.dat”. In this case, it is necessary to determine whether the definition file was correctly generated after the n-th ordered work before the (n+1)-th ordered work in the mission-critical server.

Therefore, it is desirable to set the work to output content of the definition file “/def/customer.dat” to standard output by using a “cat” command as the limited executable definition associated with a local range “between n-th and (n+1)-th”. Then, a command “cat/def/customer.dat” can be executed only between the n-th ordered work and the (n+1)-th ordered work.

FIG. 6 illustrates an example of a work procedure manual edit screen in the second embodiment. For example, the work procedure manual 207c is edited via a work procedure manual edit screen 310 displayed on a display by the operation terminal 300 and the terminal interface unit 203. The work procedure manual edit screen 310 is an example of the screen 301 illustrated in FIG. 2.

The work procedure manual edit screen 310 includes a menu bar 311, a tree display area 312, a meta-information display area 313, a content display area 314, and a button display area 315.

The menu bar 311 provides menus “file”, “edit”, “view”, “approve”, “distribute”, and “help”. FIG. 6 also illustrates shortcut keys to select the respective menus, such as “F”.

The file menu is a menu to select and open a work procedure manual to be edited and to store an edit result. The edit menu is a menu for a typical character string edit operation, such as copy, cut, and paste.

The view menu is a menu to switch the display in the content display area 314 and provides display of a list of ordered works, a list of unordered works, a list of ordered and unordered works, and a list of formulas. In the content display area 314 in FIG. 6, a list of ordered works is shown with a “work No.” column indicating the order from 1 to 10 and a “content of work” column indicating command character strings.

The approve menu is a menu to approve a work procedure manual by the administrator 502. For example, if the approve menu is selected when the work procedure manual 207c is selected, the operation terminal 300 displays a new screen 301 including an “approve” button. Then, the operation terminal 300 detects a press of the “approve” button and notifies the terminal interface unit 203, so that the terminal interface unit 203 changes the status of the work procedure manual 207c to “approved”.

The approve menu is provided to prevent the work procedure manual 207c from being inappropriately edited by mistake, if the inappropriate work procedure manual 207c is transmitted to the work target server 400 and mandatory access control is executed on the basis of the inappropriate work procedure manual 207c. The administrator 502 visually confirms the content of the work procedure manual 207c and approves it if there is no problem.

Alternatively, the test server 100 illustrated in FIG. 2 may further include functions equivalent to the work supporting unit 404, the mandatory access control unit 405, the work procedure manual receiving unit 406, the access control setting auto-generating unit 409, the work result recording unit 411, and the work result transferring unit 413. Also, the management server 200 may transmit the edited work procedure manual 207c to the test server 100.

In this case, the test server 100 receives instructions to execute mandatory access control based on the edited work procedure manual 207c from the administrator 502 and executes mandatory access control based on the edited work procedure manual 207c. Accordingly, the administrator 502 can determine the correctness of the edited work procedure manual 207c with reference to the result of the mandatory access control executed in the test server 100. Then, the administrator 502 may modify the edited work procedure manual 207c as necessary via the screen 301 of the operation terminal 300 and may finally approve it.

The distribute menu is a menu used by the worker 501 or the administrator 502 to specify a work target server to which the selected work procedure manual is to be distributed by using a host name or an IP (Internet Protocol) address.

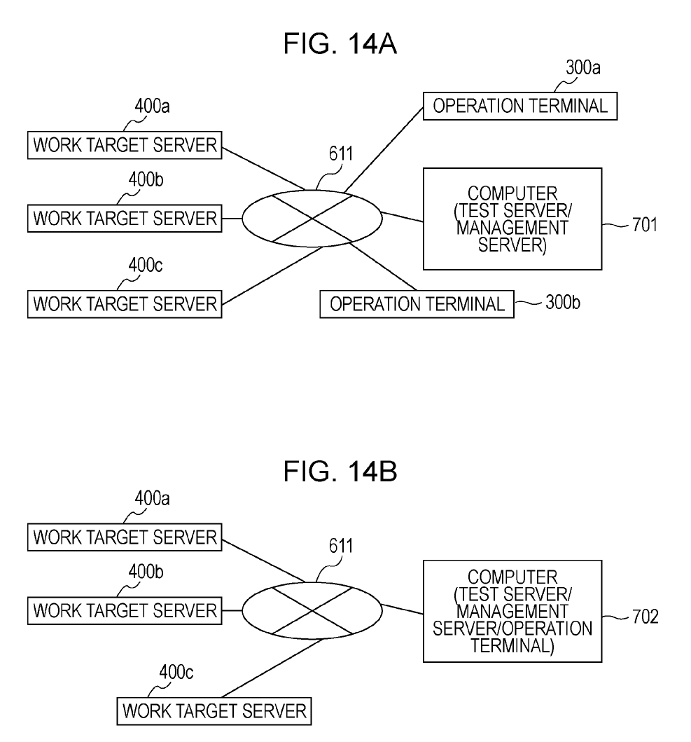

For example, in the case where the work procedure manual 207c illustrated in FIG. 2 is selected, if the work target server 400 is specified via the distribute menu, the work procedure manual transferring unit 204 transfers the edited work procedure manual 207c to the work target server 400 in step S210 in FIG. 3. In modifications described below with reference to FIGS. 14A and 14B, a plurality of work target servers 400a to 400c may be specified for the single work procedure manual 207c via the distribute menu.

The help menu is a menu to display help about the work procedure manual edit screen 310.

The tree display area 312 is an area to display a tree-like list of work procedure manuals classified by test server. In the example illustrated in FIG. 6, a tree structure corresponding to three test servers: test server 100, test server 110, and test server 120, is displayed. The work procedure manual “20080131_{—}001” in the test server 100 (hereinafter this work procedure manual is regarded as the work procedure manual 207c in FIG. 2) is selected and highlighted.

In the meta-information display area 313, meta-information about the selected work procedure manual 207c is displayed. For example, in the case where the work procedure manuals 207a and 207b are combined into the work procedure manual 207c and the work procedure manual 207c is stored, meta-information is written in the work procedure manual 106 in step S201 in FIG. 3 when each of the work procedure manuals 207a and 207b is generated as the work procedure manual 106 in the test server 100. Thus, part of the meta-information included in the work procedure manual 207c may be inherited from the work procedure manuals 207a and 207b. Also, part of the meta-information of the work procedure manual 207c may be generated by the terminal interface unit 203 and may be written in the work procedure manual 207c when the work procedure manual 207c is generated through combining.

In the example illustrated in FIG. 6, the test server 100 that generated the work procedure manuals 207a and 207b as work procedure manuals 106 is displayed in a field “procedure manual created by”, and a user name of the worker 501 who edits the work procedure manual 207c is displayed in a field “worker”. Also, the date and time when the work procedure manual 207c is created through combining is displayed in a field “date of creation”.

The type of work of the work procedure manual 207c is displayed in a field “name of work”. The content of the field “name of work” can be edited via the operation terminal 300 and the terminal interface unit 203. The edit result is reflected on the work procedure manual 207c.

After the work procedure manual 207c has been edited via the operation terminal 300 and the terminal interface unit 203, the terminal interface unit 203 recognizes the date and time of the edit and notifies the operation terminal 300, so that the date and time are displayed in a field “date of last update”.

The content specified by the view menu is displayed in the content display area 314. In FIG. 6, a list of ten ordered works is displayed. The example illustrated in FIG. 6 shows the content of the following (1) to (10), which includes a series of works to provide a new service named as “newservice”.

(1) Obtain an archived and compressed file “001.zip” from an FTP (File Transfer Protocol) server.

(2) Unarchive the obtained file in a “/work” directory.

(3) Install software to provide the new service by using an installer obtained through the unarchiving in (2).

(4) Perform setting of the software installed in (3) by using a setting tool obtained through the unarchiving in (2).

(5) Determine whether setting in (4) has been normally performed.

(6) Determine whether a file necessary to provide the new service exists.

(7) Apply modification to the software installed in (3) by using a modification application tool obtained through the unarchiving in (2).

(8) Reboot OS.

(9) Make setting so that the new service automatically boots at reboot of the OS.

(10) Boot the new service.

In the button display area 315, buttons “add work”, “change procedure”, “delete work”, “edit formula”, and “combine procedures” are displayed.

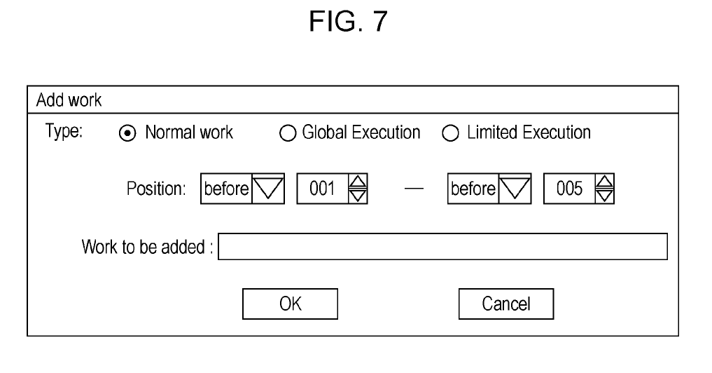

When detecting a press of the “add work” button, the operation terminal 300 displays a work adding screen 320 to add a work illustrated in FIG. 7.

When detecting a press of the “change procedure” button, the operation terminal 300 displays a screen to make various changes, such as change of content of respective works, reordering the works, and change of the type of work (ordered work, global executable definition, and limited executable definition). The screen displayed in response to a press of the “change procedure” button is not illustrated, but it is clear that an input necessary to provide instructions to make a change can be obtained through a screen similar to that illustrated in FIG. 7 described below.

When detecting a press of the “delete work” button, the operation terminal 300 specifies one or a plurality of works from among the works included in the currently-selected work procedure manual and displays a screen to delete the specified work(s). Illustration of the screen used for deletion is omitted.

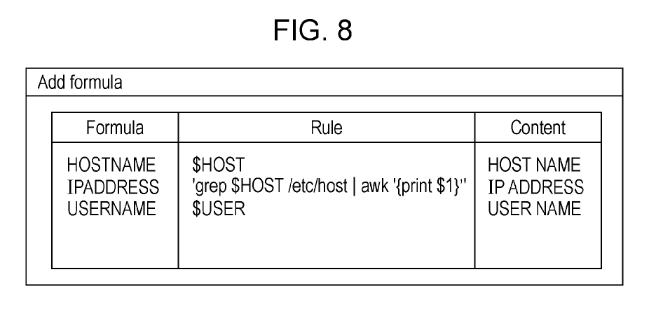

When detecting a press of the “edit formula” button, the operation terminal 300 displays a formula edit screen 330 illustrated in FIG. 8. The meaning of “formula” is described below with reference to FIG. 8.

When detecting a press of the “combine procedures” button, the operation terminal 300 displays a screen to input instructions to combine a plurality of work procedure manuals into a single manual. Illustration of the screen used for combining is omitted.

For example, when a work procedure including reboot or shutdown is executed in the test server 100, generation of the work procedure manual 106 is once completed at the time of reboot or shutdown, and the work procedure manual 106 is transmitted to the management server 200. Then, the work procedure restarted after reboot is captured and is generated as another new work procedure manual 106, which is transmitted to the management server 200 again. For example, the work procedure manuals 207a and 207b may be the work procedure manuals that are transmitted to the management server 200 twice in this way.

In this case, the operation terminal 300 detects a press of the “combine procedures” button, receives an input indicating instructions to combine the work procedure manuals 207a and 207b into the work procedure manual 207c and store the work procedure manual 207c, and outputs the received input to the terminal interface unit 203. In accordance with the input received from the operation terminal 300, the terminal interface unit 203 combines the work procedure manuals 207a and 207b into the work procedure manual 207c and stores the work procedure manual 207c. In the example illustrated in FIG. 6, the first to eighth works derive from the work procedure manual 207a whereas the ninth to tenth works derive from the work procedure manual 207b.

Next, the work adding screen displayed upon press of the “add work” button illustrated in FIG. 6 is described as another specific example of the screen 301 illustrated in FIG. 2.

FIG. 7 illustrates an example of the work adding screen in the second embodiment. In FIG. 7, the work adding screen 320 includes radio buttons of the following three options (1) to (3) indicating the types of work to be added to the work procedure manual.

(1) “Normal work” indicating an ordered work

(2) “Global Execution” indicating the global executable definition defined in FIG. 5

(3) “Limited Execution” indicating the limited executable definition defined in FIG. 5

Also, the work adding screen 320 includes an input field indicating the position where the work is to be added. The position input field includes a pull-down list to specify the order at a start position, a pull-down list to select “before” or “after”, a pull-down list to specify the order at an end position, and a pull-down list to select “before” or “after”. When the selected work procedure manual includes N ordered works, the two pull-down lists indicating the order are generated by the terminal interface unit 203 or the operation terminal 300 so that any of 1 to N can be selected.

If “normal work” is selected with the radio button, the operation terminal 300 disables the latter two pull-down lists in the position input field by using grayout display. Thus, for example, when a new ordered work is to be added between the first and second ordered works, the worker 501 or the administrator 502 specifies the position “before 002” or “after 001”. The operation terminal 300 receives an input of the specified position.

If “Global Execution” is selected with the radio button, the operation terminal 300 disables the position input field by using grayout display. This is because, as described above with reference to FIG. 5, the global range corresponding to the global executable definition is predetermined according to an embodiment.

If “Limited Execution” is selected with the radio button, the operation terminal 300 receives an input indicating the range “from before 001 to before 005” from the position input field.

The work adding screen 320 further includes a text input field headed as “work to be added”. The operation terminal 300 receives a command character string input to the “work to be added” field.

Also, the work adding screen 320 includes an “OK” button and a “cancel” button. When detecting a press of the “OK” button, the operation terminal 300 transmits the type selected with the radio button, the position or range specified as necessary, and the command character string to the terminal interface unit 203. The terminal interface unit 203 receives the data input via the work adding screen 320 from the operation terminal 300 and adds the work corresponding to the received data to the selected work procedure manual.

Next, the formula edit screen displayed upon press of the formula edit button illustrated in FIG. 6 is described as another specific example of the screen 301 illustrated in FIG. 2.

FIG. 8 illustrates an example of the formula edit screen in the second embodiment. In the following description, “formula” is an expression to obtain a value corresponding to a command execution environment.

A value corresponding to a command execution environment needs to be specified for an argument of some kind of command. For example, the test server 100 and the work target server 400 may require arguments of different values. In the examples described below with reference to FIGS. 14A and 14B, the same work procedure manual is distributed to a plurality of work target servers 400a to 400c, but the respective work target servers 400a to 400c may require arguments of different values.

The definition of a work procedure manual can be made variable by defining an expression to obtain a value corresponding to an execution environment as a formula and by defining a work including the formula in the work procedure manual. Thus, by using the formula, execution environment dependency can be absorbed, and the work procedure manual can be generated and edited efficiently and easily even when the plurality of work target servers 400a to 400c exist.

The formula edit screen 330 illustrated in FIG. 8 includes columns “formula”, “rule”, and “content”. The “formula” column is a column to specify a character string as an identifier representing a formula, the “rule” column is a column to specify an expression to obtain a value according to an execution environment, and the “content” column is a column to specify a brief explanation representing the content of the formula.

In the example illustrated in FIG. 8, a formula “HOSTNAME” representing the host name of the execution environment is associated with an expression “$HOST” to refer to a value of an environment variable indicating the host name. Also, a formula “IPADDRESS” representing the IP address of the execution environment is associated with an expression “‘grep $HOST/etc/host|awk‘{print $1}’’”, including two commands connected by a pipe and enclosed with backquote. Also, a formula “USERNAME” representing the user name of the execution environment is associated with an expression “$USER” to refer to a value of an environment variable indicating the user name.

Character strings in the “formula” column can be arbitrarily set. In the “rule” column, expressions that can be evaluated by the execution environment, i.e., by the OS 403 of the work target server 400, can be appropriately described.

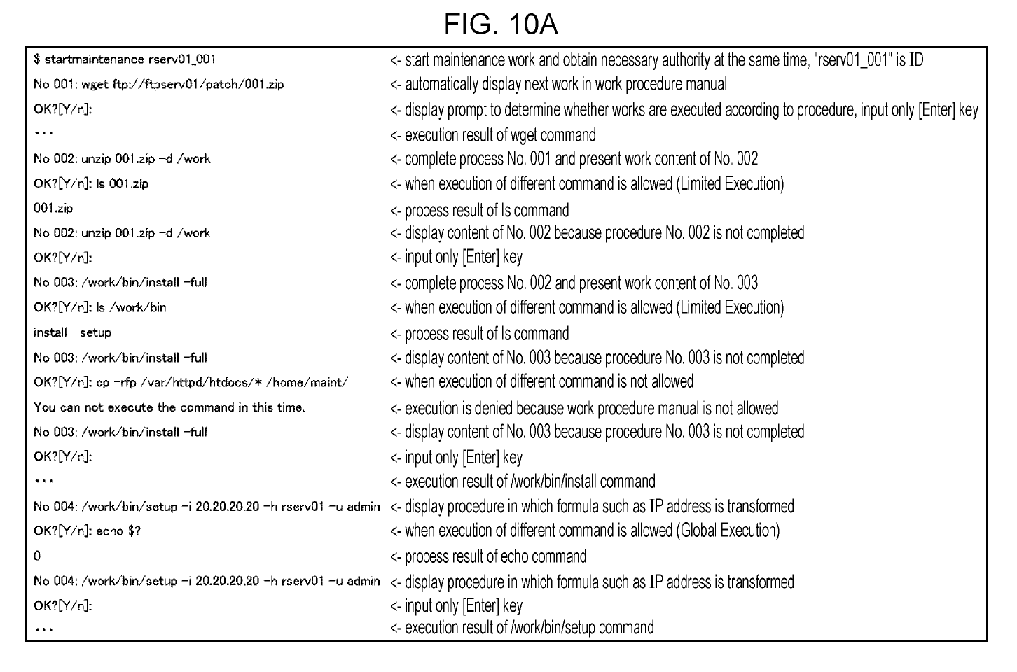

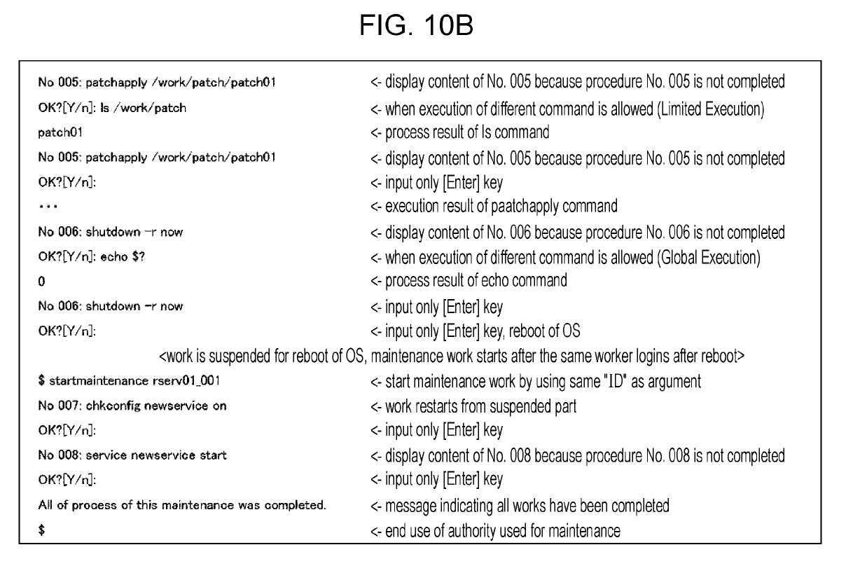

Hereinafter, an example of a final work procedure manual that has been edited via the screens illustrated in FIGS. 6 to 8 is described with reference to FIG. 9. Also, the progress and result of execution of mandatory access control based on the work procedure manual illustrated in FIG. 9 are described with reference to FIGS. 10A to 12.

FIG. 9 illustrates an example of the work procedure manual in the second embodiment. For example, FIG. 9 illustrates the state where the work procedure manual 207c illustrated in FIG. 2 has been edited. In FIG. 9, the meta-information described above with reference to FIG. 6 is omitted.

Referring to FIG. 9, a line starting from “G” indicates the definition of an unordered work of the global executable definition, and a line starting from “L” indicates the definition of an unordered work of the limited executable definition. A line starting from “%” indicates the definition of a formula, and a line starting from a numeric indicates the definition of an ordered work.

“G, echo $?” in the first line indicates that the command “echo $?” representing a resetting value of the previously-executed command is the global executable definition.

“L, 1, 8, is *” in the second line indicates a definition example of the limited executable definition where the “ls” command can be arbitrarily executed any number of times in the range defined by first and eighth, i.e., in the range from immediately before the first ordered work to immediately before the eighth ordered work. Note that the argument of the “ls” command in the second line is specified as “*” using a wildcard. This means that, even if any argument is actually specified as argument of the “ls” command, execution is allowed in the range defined by the first and eighth.

The third to fifth lines indicate definition of formulas. Before comma is a character string enclosed with % defined in the “formula” column in FIG. 8, whereas after comma is an expression defined in the “rule” column in FIG. 8.

The sixth to thirteenth lines indicate the definitions of the first to eighth ordered works, respectively. Before comma is a numeric indicating the order, whereas after comma is a command character string representing a work.

The first to third ordered works are the same as those in FIG. 6. In the fourth ordered work, the arguments included in the command character string in FIG. 6 are replaced by formulas enclosed with %.

The fifth ordered work in FIG. 6, the type thereof being changed to global executable definition by edit, corresponds to the first line in FIG. 9. Likewise, the sixth ordered work in FIG. 6, the type thereof being changed to limited executable definition by edit, the argument also being changed, corresponds to the second line in FIG. 9.

The fifth to eighth ordered works in FIG. 9 correspond to the seventh to tenth ordered works in FIG. 6.

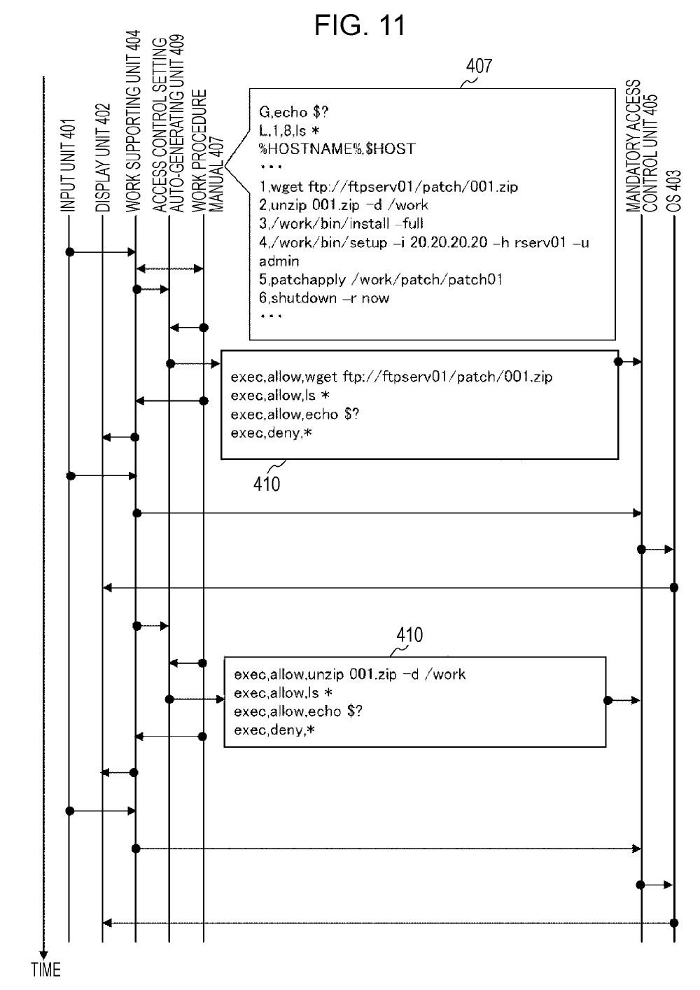

Next, a specific example of mandatory access control based on the work procedure manual illustrated in FIG. 9 is described with reference to FIGS. 10A to 11.

FIGS. 10A and 10B illustrate an example of the command line interface of the work target server in the second embodiment. FIG. 11 is a timing chart specifically illustrating part of FIG. 10A. In the respective lines in FIGS. 10A and 10B, “<-” and the right side thereof show explanations that are displayed for convenience and are not actually displayed in the command line interface.

In the first line in FIG. 10A, a symbol “$” representing a command prompt to a general user, a command name “startmaintenance”, and an argument “rserv01_{—}001” are displayed.

Here, the command name “startmaintenance” indicates a program to execute mandatory access control according to the second embodiment. That is, the “startmaintenance” command realizes the work supporting unit 404, the mandatory access control unit 405, the work procedure manual receiving unit 406, the access control setting auto-generating unit 409, the work result recording unit 411, and the work result transferring unit 413 illustrated in FIG. 2. Of course, an arbitrary command name other than “startmaintenance” can be used according to an embodiment.

The “startmaintenance” command in this embodiment requires one argument, and the argument is interpreted as an ID of the work procedure manual. In FIG. 10A, an argument “rserv01_{—}001” is given.

For example, assume that the ID 208c having a value “rserv01_{—}001” is assigned to the work procedure manual 207c that has been edited via the operation terminal 300. The terminal interface unit 203 and the operation terminal 300 notify the worker 501 and the administrator 502 of the ID 208c assigned to the work procedure manual 207c via the screen 301.

The worker 503 can know the value of the ID 208c via the operation terminal 300 if the worker 503 is the same person as the worker 501. Alternatively, the administrator 502 may notify the worker 503 of the value of the ID 208c. In any case, the worker 503 recognizes that the value of the ID 208c corresponding to the work procedure manual 207c is “rserv01_{—}001”, i.e., the value of the ID 408 corresponding to the work procedure manual 407 that is to be used for mandatory access control is “rserv01_{—}001”. Thus, the worker 503 specifies “rserv01_{—}001” as an argument of the “startmaintenance” command.

Then, as indicated by an arrow in FIG. 11, the input unit 401 outputs the received command character string “startmaintenance rserv01_{—}001” to the work supporting unit 404. Then, as in step S301 in FIG. 4, the work supporting unit 404 starts an operation and obtains a necessary authority.

Also, as in step S302, the work supporting unit 404 determines whether the work procedure manual 407 corresponding to the argument exists, i.e., whether the correct ID 408 has been specified as an argument. Then, as in step 304, start of the work is output to the work record 412. Note that, in FIG. 11, the work result recording unit 411 and the work result transferring unit 413 related to the work record 412 are omitted.

Then, the work supporting unit 404 recognizes that the number of executed ordered works is 0 and sets 0 to the counter variable k. The counter variable k can be operated also from the mandatory access control unit 405 and the access control setting auto-generating unit 409.

Also, the work supporting unit 404 performs replacement of formulas in step S304. Specifically, the work supporting unit 404 obtains definition of formulas from the work procedure manual 407 and replaces the formulas enclosed with in the command character string in the work procedure manual 407 by values evaluating expressions.

In the example illustrated in FIG. 9, the fourth ordered work includes three formulas. Thus, the work supporting unit 404 obtains the host name “rserv01” of the work target server 400, the IP address “20.20.20.20” of the work target server 400, and the user name “admin” in accordance with definition of the formulas in the work procedure manual 407 illustrated in FIG. 9.

Then, the work supporting unit 404 replaces the three formulas in the fourth ordered work in the work procedure manual 407 in FIG. 9 by the respective obtained values. When an unordered work includes a formula, the work supporting unit 404 performs replacement in the same way. FIG. 11 illustrates the work procedure manual 407 after replacement (some lines are omitted for convenience of illustration).

Then, in step S308, the mandatory access control unit 405 generates the access control setting 410 by referring to the work procedure manual 407 in response to the instructions from the work supporting unit 404.

In this stage, the value of the counter variable k indicating the number of executed ordered works is 0, and thus the ordered work that is allowed to be executed is K+1=first ordered work “wget ftp://ftpserv01/patch/001.zip”. Also, an unordered work associated with the range including the first is also allowed to be executed. Specifically, “echo$?” of the global executable definition and “ls*” of the limited executable definition associated with the range “from immediately before the first ordered work to immediately before the eighth ordered work” can be executed.

An arbitrary data format can be used in the access control setting 410. In this embodiment, however, the access control setting 410 is expressed in the format illustrated in FIG. 11. Each line in the access control setting 410 in FIG. 11 includes a character string “exec” representing the control related to execution access, a comma, a character string “allow” representing allowance or a character string “deny” representing denial, a comma, and content of the work.

As described above, execution of only three works is allowed in this stage. Thus, the first to third lines of the access control setting 410 include command character strings representing the three works that are allowed to be executed. In the fourth line that is the last line, “deny” representing denial is specified, and “*” at the end of the fourth line represents that all the commands except those described in the first to third lines are denied.

As described above, the access control setting 410 is written in a white list method in which executable works are expressly listed. The white list method can realize a higher level of safety compared to a black list method in which unexecutable works are listed.

After the access control setting 410 is generated in step S308 in this way, the process proceeds to step S309, where the work supporting unit 404 refers to the work procedure manual 407 and allows the display unit 402 to display the first work in the unexecuted ordered works, i.e., the first ordered work.

In FIG. 10A, a character string “No 001:” representing the first order is displayed in step S309, and also a command character string representing the first ordered work is displayed thereafter. Furthermore, the display unit 402 displays a prompt “OK?[Y/n]:” in the third line in FIG. 10A in response to the instructions from the work supporting unit 404. This prompt is for determining whether the command “wget ftp://ftpserv01/patch/001.zip” displayed in the second line is to be executed in accordance with the work procedure manual 407.

The display in the second to third lines in FIG. 10A is indicated by an arrow from the work supporting unit 404 to the display unit 402 in FIG. 11.

In this embodiment, a default response to a prompt is “Y” standing for “Yes”, and the character “Y” is displayed in uppercase to indicate a default response. In this embodiment, the work supporting unit 404 regards a press of an enter key as a default response.

In the example illustrated in FIG. 10A, the enter key is pressed for the prompt in the third line. That is, the press of the enter key corresponds to instructions to execute the command “wget ftp://ftpserv01/patch/001.zip” displayed in the second line.

In step S310, the input unit 401 notifies the work supporting unit 404 of the received input content, i.e., the input content of the press of the enter key. This notification is indicated by an arrow from the input unit 401 to the work supporting unit 404 in FIG. 11.

Also, in step S310, the work supporting unit 404 notifies the mandatory access control unit 405 that instructions to execute the command “wget ftp://ftpserv01/patch/001.zip” have been provided, and instructs the mandatory access control unit 405 to execute mandatory access control in accordance with the access control setting 410. The notification and instructions are indicated by an arrow from the work supporting unit 404 to the mandatory access control unit 405 in FIG. 11.

The execution of the command “wget ftp://ftpserv01/patch/001.zip” to be executed by the press of the enter key is of course allowed in the access control setting 410 generated above. Thus, in step S312 after recording of the work record 412 in step S311, the mandatory access control unit 405 instructs the OS 403 to execute the command “wget ftp://ftpserv01/patch/001.zip”. The instructions are indicated as an arrow from the mandatory access control unit 405 to the OS 403 in FIG. 11.

The execution of the command causes the value of the counter variable k indicating the number of executed ordered works to be incremented by one. In step S313, the OS 403 allows the display unit 402 to display a process result as indicated by an arrow in FIG. 11.

Then, the process returns to step S305, and the access control setting auto-generating unit 409 generates the access control setting 410 again in the manner described above in step S308. Here, the value of the counter variable k indicating the number of executed ordered works is 1, and thus the work allowed to be executed includes a command “unzip 001.zip-d/work” of the k+1=second ordered work. Furthermore, the access control setting 410 indicates allowance of execution of “echo$?” of the global executable definition and “ls*” of the limited executable definition associated with the range defined by the first and eighth (i.e., the range including the second), as illustrated in FIG. 11.

Then, in step S309, the display unit 402 displays the command character string representing the second ordered work and the prompt “OK?[Y/n]:” in the same manner as described above.

In this case, the worker 503 negatively responds to the prompt. That is, the worker 503 inputs a command “ls 001.zip” different from the displayed command. As shown in the second access control setting 410 in FIG. 11, the input command matches an executable command.

Therefore, the command “ls 001.zip” is executed by the OS 403 via the mandatory access control unit 405 in the same manner as described above. Then, in step S313, the display unit 402 displays “001.zip” as a process result, as illustrated in FIG. 10A.

Thereafter, although a detailed description of the process is omitted, the access control setting 410 is dynamically generated again and again in the same manner as described above, and the mandatory access control unit 405 executes mandatory access control on the basis of the new access control setting 410. The outline of the process is described below along the displayed content illustrated in FIGS. 10A and 10B.

Since the “unzip 001.zip-d/work” command, which is the second ordered work, has not been completed, the content of the second ordered work and the prompt are displayed again. Then, the enter key is pressed, whereby the second ordered work is executed. The second ordered work does not involve an output, and thus the display unit 402 does not display a process result.

Then, a command character string “/work/bin/install-full” as the content of the third ordered work and the prompt are displayed. Another “ls” command is input for this prompt, but the mandatory access control unit 405 allows execution of the input “ls” command, the OS 403 executes the “ls” command, and the display unit 402 displays a process result.

Then, since the execution of the third ordered work has not been completed, the content of the third ordered work and the prompt are displayed again. Another “cp” command is input for this prompt.

However, the “cp” command is not defined as the global executable definition in the work procedure manual 407 in FIG. 9 and is not defined as the limited executable definition associated with the range including the order of third. Thus, execution of the input “cp” command is denied by the mandatory access control unit 405 on the basis of the access control setting 410.

Then, in step S314, the display unit 402 displays an error message You can not execute the command in this time so as to notify the worker 503 that execution of the command was denied. Then, the process returns to step S309, where the content of the third ordered work and the prompt are displayed again.

The enter key is pressed this time, the third ordered work is executed, and a process result is displayed.

Then, a “/work/bin/setup” command representing the fourth ordered work and a prompt are displayed. Here, the three arguments in the fourth ordered work are described as formulas in the original work procedure manual 407 as illustrated in FIG. 9. However, the formulas have been replaced by the arguments in step S304 as described above. Thus, a command character string “/work/bin/setup-i 20.20.20.20-h rserv0′-u admin” using the values after replacement is displayed as the character string representing the fourth ordered work.

As illustrated in FIG. 10A, instructions to execute a different command are input for the prompt here. However, the “echo$?” command is defined as the global executable definition in the work procedure manual 407 and thus the execution thereof is allowed by the mandatory access control unit 405. Thus, a process result is displayed in step S313, the process returns to step S305, and then the command character string representing the fourth ordered work and the prompt are displayed again in step S309.

The enter key is pressed this time, the fourth ordered work is executed, and a process result is displayed.

Referring to FIG. 10B, since execution of the fifth ordered work represented by a command character string “patchapply/work/patch/patch01” has not been completed, the content of the fifth ordered work and the prompt are displayed. Another “ls” command is input for this prompt. The “ls” command is defined as the limited executable definition associated with the range including the order of fifth, and thus the execution thereof is allowed by the mandatory access control unit 405, and a process result is displayed.

Then, since execution of the fifth ordered work has not been completed, the content of the fifth ordered work and the prompt are displayed again. The enter key is pressed this time, the fifth ordered work is executed, and a process result is displayed.

Then, since execution of the sixth ordered work has not been completed, the content of the sixth ordered work represented by a command character string “shutdown -r now” and a prompt are displayed. Here, instructions to execute a different command are input for the prompt here. The “echo$?” command is defined as the global executable definition, and thus the execution thereof is allowed and a process result is displayed.

Then, since execution of the sixth ordered work has not been completed, the content of the sixth ordered work and the prompt are displayed again. The enter key is pressed this time, and the sixth ordered work is executed. The sixth ordered work is represented by a command of reboot. Thus, the OS 403 reboots at this time.

After reboot of the OS 403, the worker 503 logins to the work target server 400 again. Then, the worker 503 inputs the “startmaintenance” command by using the ID 408 having a value “rserv01_{—}001” as an argument.

Then, in step S304, the work supporting unit 404 recognizes that the number of executed ordered works is 6 on the basis of the work record 412 and sets 6 to the counter variable k. Thus, in step S309, the content of the seventh ordered work and the prompt are displayed so that the work procedure manual 407 is restarted from the work at the suspension due to the reboot, i.e., from the seventh ordered work in the work procedure manual 407.

The enter key is pressed for the prompt, so that the seventh ordered work represented by a command character string “chkconfig newservice on” is executed. In this embodiment, a “chkconfig” command does not involve an output, and thus a process result is not displayed. Then, the content of the eighth ordered work and a prompt are displayed.

The enter key is pressed for the prompt, so that the eighth ordered work represented by a command character string “service newservice start” is executed. In this embodiment, a “service” command does not involve an output, and thus a process result is not displayed in step S313 and the process returns to step S305.

In this way, all the eight ordered works defined in the work procedure manual 407 have been executed, and thus the process proceeds from step S306 to S307. In step S307, the work supporting unit 404 instructs the display unit 402 to display a message indicating the completion of the work procedure, whereby the display unit 402 displays the message. Also, the work supporting unit 404 ends the use of the authority obtained in step S301. Then, the process illustrated in FIG. 4 ends, so that a symbol “$” representing a command prompt for a general user is displayed in the command line interface of the display unit 402, as illustrated in FIG. 10B.

In the example illustrated in FIGS. 10A to 11, the work procedure is automatically suspended once due to the reboot work included in the work procedure manual 407. However, execution of the work procedure can be artificially suspended at an arbitrary time point.

For example, when the worker 503 performs a specific key input to end a job in the state where the prompt “OK?[Y/n]:” is displayed, execution of the “startmaintenance” command can be stopped, whereby execution of the work procedure can be suspended. Even when execution of the work procedure is suspended at an arbitrary time point, the execution of the work procedure can be correctly restarted from the point immediately after the suspension in the same method as in the example illustrated in FIG. 10B.

Next, a description is given about verification after execution of the work procedure in the work target server 400.

FIG. 12 illustrates an example of a work record confirmation screen in the second embodiment. A work result confirmation screen 340 illustrated in FIG. 12 is an example of the screen 301 that is displayed in the operation terminal 300 in step S216 in FIG. 3.

The terminal interface unit 203 transmits, to the operation terminal 300, data necessary to display the work result confirmation screen 340 to compare the work procedure manual 207c and the work record 209c associated with the same ID 208c. The operation terminal 300 displays the work result confirmation screen 340 on the basis of the data received from the terminal interface unit 203.

The work result confirmation screen 340 includes a table including three columns: a type column 341; a work procedure manual column 342; and a work record column 343, an explanatory note 344, an “OK” button, and a “cancel” button. In the work result confirmation screen 340, the work procedure manual 207c and the work record 209c are graphically displayed in the same form, which enables the administrator 502 to easily make a comparison and to easily recognize the existence of a problem.

In the work record column 343, the works actually specified to be executed in the work target server 400 are displayed while being listed in the order of specification. As illustrated in the example in FIGS. 10A and 10B, instructions to execute a work are provided in the following manner (1) or (2).

(1) Instructions to execute the ordered work represented by the command character string displayed in the prompt are provided through a press of the enter key.

(2) Instructions to execute an arbitrary work are provided through an input of a command character string.

Command character strings representing the respective works specified to be executed in the manner (1) or (2) are displayed in the respective rows in the work record column 343. An empty row indicates reboot of the OS 403 in the work target server 400.

In the respective rows of the table, the types and explanations of the works represented by the command character strings in the work record column 343 are shown in the type column 341 and the work procedure manual column 342 in the following manner.

(1) In the case where the work record column 343 shows an ordered work, instructions to execute the ordered work being provided in a correct order, the numeric indicating the order is displayed in the type column 341. In the work procedure manual column 342, a command character string representing the ordered work is displayed in the state where a formula is replaced.

(2) In the case where the work record column 343 shows an unordered work of the limited executable definition, instructions to execute the unordered work being provided at the timing when execution is allowed, “allow” is displayed in the type column 341. Also, “Limited Execution” is displayed in the work procedure manual column 342.

(3) In the case where the work record column 343 shows an unordered work defined as the global executable definition, “allow” is displayed in the type column 341. Also, “Global Execution” is displayed in the work procedure manual column 342.

(4) In the case where the work record column 343 is empty indicating reboot, “suspend” is displayed in the type column 341, and the work procedure manual column 342 is empty.

(5) In the case other than (1) to (4), “deny” is displayed in the type column 341, and the work procedure manual column 342 is empty.

With the above-described display for comparison, the administrator 502 can easily determine whether works have been appropriately executed in accordance with the work procedure manual 207c only by viewing the work result confirmation screen 340. In FIG. 12, all the rows in the table are shown with a white background and black characters for convenience of illustration. However, the colors of the background and characters and the font of the respective rows may be different from each other in accordance with the types shown in the type column 341.

For example, five background colors can be used in accordance with the types described above in (1) to (5). The types represented by the five background colors are shown in five rectangles in the explanatory note 344. Such different appearances according to the types enable the administrator 502 to easily recognize the existence of a problem by comparing the work procedure manual 207c and the work record 209c in the respective works.

The operation terminal 300 closes the work result confirmation screen 340 when detecting a press of the “OK” button or the “cancel” button.

FIG. 13 illustrates a configuration of a computer. Any of the test server 100, the management server 200, the operation terminal 300, and the work target server 400 has the configuration of the computer 600 illustrated in FIG. 13.

The computer 600 includes a CPU (Central Processing Unit) 601, a ROM (Read Only Memory) 602, a RAM 603, a communication interface 604, an input device 605, an output device 606, a storage device 607, and a driving device 608. Those respective devices are mutually connected via a bus 609. The computer 600 can obtain information stored in a computer-readable portable storage medium 610 via the driving device 608.

Also, the computer 600 connects to a network 611 via the communication interface 604. The network 611 is an arbitrary network, such as a LAN (Local Area Network) or the Internet. Other than the computer 600, a program provider 612 and another computer 613 may be connected to the network 611.

The CPU 601 loads a program to the RAM 603 and executes the program by using the RAM 603 as a working area. The program may be stored in the ROM 602 or the storage device 607 in advance, or may be provided from the program provider 612 via the network 611 and may be stored in the storage device 607.

Alternatively, the program may be stored in the portable storage medium 610 and may be loaded to the RAM 603 from the portable storage medium 610 set in the driving device 608. As the portable storage medium 610, various types of storage media can be used, e.g., an optical disc such as a CD (Compact Disc) or a DVD (Digital Versatile Disc), a magneto-optical disc, a magnetic disk, and a nonvolatile semiconductor memory.

The input device 605 includes a pointing device, such as a mouse, and a keyboard. The output device 606 includes a display device, such as a liquid crystal display. The storage device 607 may be a magnetic disk device, such as a hard disk device, or may be another type of storage device.

For example, in the case where the test server 100 is realized by the computer 600, the input unit 101 is realized by the input device 605 and the CPU 601 that executes a program for the command line interface. The OS 103 is stored in the storage device 607, is loaded to the RAM 603, and is executed by the CPU 601.

The work content capturing unit 104 and the work procedure manual generating unit 105 are realized when the CPU 601 executes a program. The work procedure manual transferring unit 107 is realized by the CPU 601 and the communication interface 604. That is, in the case where the test server 100 is realized by the computer 600, the program executed by the CPU 601 is a program corresponding the process including steps S201 to S206 illustrated in FIG. 3.

In the case where the test server 100 is realized by the computer 600, the management server 200, the operation terminal 300, and the work target server 400 may be connected to the network 611 as the other computer 613.

In the case where the management server 200 is realized by the computer 600, the work procedure manual receiving unit 201, the terminal interface unit 203, the work procedure manual transferring unit 204, and the work record receiving unit 205 are realized by the CPU 601 and the communication interface 604.

That is, in this case, one of the programs executed by the CPU 601 is a program to execute steps S207 to S208 illustrated in FIG. 3 in cooperation with the operation terminal 300 and to execute steps S209 to S210 continuously. The CPU 601 also executes a program to perform step S216 in cooperation with the operation terminal 300.

In the case where the management server 200 is realized by the computer 600, the work procedure manual storing unit 202 and the work record storing unit 206 are realized by the storage device 607. Also, the test server 100, the operation terminal 300, and the work target server 400 may be connected to the network 611 as the other computer 613.

In the case where the operation terminal 300 is realized by the computer 600, the output device 606 displays the screen 301 in response to instructions from the CPU 601, and the input device 605 receives an input from the worker 501 and the administrator 502. The input received by the input device 605 is processed by the CPU 601 as necessary and is transmitted from the communication interface 604 to the management server 200 via the network 611.

That is, in the case where the operation terminal 300 is realized by the computer 600, one of the programs executed by the CPU 601 is a program to perform steps S207 and S208 in FIG. 3 in cooperation with the management server 200. The CPU 601 also executes a program to perform step S216 in cooperation with the management server 200.

In this case, the test server 100, the management server 200, and the work target server 400 may be connected to the network 611 as the other computer 613.

In the case where the work target server 400 is realized by the computer 600, the input unit 401 is realized by the input device 605 and the CPU 601 that executes a program for the command line interface. The display unit 402 is realized by the output device 606 and the CPU 601 that executes the program for the command line interface.

The OS 403 is stored in the storage device 607, is loaded to the RAM 603, and is executed by the CPU 601. The work supporting unit 404, the mandatory access control unit 405, the access control setting auto-generating unit 409, and the work result recording unit 411 are realized by the CPU 601 that executes the programs. The work procedure manual receiving unit 406 and the work result transferring unit 413 are realized by the CPU 601 and the communication interface 604.

That is, in the case where the work target server 400 is realized by the computer 600, the CPU 601 executes a program of the process including steps S211 to S215 in FIG. 3 in addition to the above-described program for the OS 403 and the command line interface. In other words, the CPU 601 executes the program of the process illustrated in FIG. 4.

The work procedure manual 407, the ID 408, and the work record 412 are stored in the storage device 607, for example, but may be stored in the RAM 603 during execution of the process illustrated in FIG. 4. The access control setting 410 that is dynamically generated is stored in the RAM 603. Also, the test server 100, the management server 200, and the operation terminal 300 may be connected to the network 611 as the other computer 613.

FIGS. 14A and 14B illustrate modifications of the second embodiment. A description about the same point as that in the second embodiment is omitted.

The system illustrated in FIG. 14A includes a plurality of work target servers 400a to 400c that have the same hardware and software configurations and that provide the same service. In order to keep the hardware and software configurations of the work target servers 400a to 400c equal to each other, a maintenance work is executed in accordance with the same work procedure manual assigned with the same ID in the work target servers 400a to 400c.

In other words, in the system illustrated in FIG. 14A, only one work procedure manual is necessary for the plurality of work target servers 400a to 400c, and thus the work procedure manual can be generated at once, which is efficient.

In the modification illustrated in FIG. 14A, a single computer 701 has functions of the test server 100 and the management server 200 illustrated in FIG. 2. The hardware and software configurations of the computer 701 are the same as those of the work target servers 400a to 400c or a subset of the work target servers 400a to 400c. The computer 701 distributes the same work procedure manual to the respective work target servers 400a to 400c.

Also, the system illustrated in FIG. 14A includes a plurality of operation terminals 300a to 300b. For example, the worker 501 illustrated in FIG. 2 may use the operation terminal 300a in the modification illustrated in FIG. 14A, whereas the administrator 502 illustrated in FIG. 2 may use the operation terminal 300b in the modification illustrated in FIG. 14A.

The above-described work target servers 400a to 400c, the computer 701, and the operation terminals 300a to 300b are mutually connected via the network 611.

Also, the system illustrated in FIG. 14B includes a plurality of work target servers 400a to 400c as the system illustrated in FIG. 14A. In the modification illustrated in FIG. 14B, a single computer 702 has functions of the test server 100, the management server 200, and the operation terminal 300 illustrated in FIG. 2. The work target servers 400a to 400c and the computer 702 are mutually connected via the network 611.

As described above, the number of work target servers and operation terminals is arbitrary. Also, the functions of the test server 100, the management server 200, and the operation terminal 300 illustrated in FIG. 2 may be combined as necessary and may be realized by a single computer or may be realized by a plurality of computers. In the modifications illustrated in FIGS. 14A and 14B, each of the computers 701 and 702 realizes the functions of the test server 100 and the management server 200 illustrated in FIG. 2, so that the work procedure manual transferring unit 107 and the work procedure manual receiving unit 201 illustrated in FIG. 2 can be omitted.

Also, in the above-described modifications, the plurality of work target servers 400a to 400c have the same hardware and software configurations and provide the same service. However, the plurality of work target servers 400a to 400c may have different hardware configurations or software configurations and may provide different services. In that case, the computer 701 generates different work procedure manuals corresponding to the respective work target servers 400a to 400c and transmits the work procedure manuals to the respective work target servers 400a to 400c.

According to the above-described second embodiment and its modifications, the following effects can be obtained.

(1) The work procedure manual 106 is automatically generated on the basis of the work procedure executed in the test server 100. The work procedure manual 106 is transferred to the management server 200 and is edited, but only a small part should be manually edited about ordered works. Thus, the final work procedure manual 207c can be efficiently generated with less effort.

(2) The final work procedure manual 207c that has been edited is transferred to the work target server 400 after the correctness of the content is approved by the administrator 502. Thus, in the work target server 400, mandatory access control based on the appropriate work procedure manual 407 without error or unnecessary work is realized.

(3) The mandatory access control in the work target server 400 can prevent execution of an incorrect work or execution of works in an inappropriate order. Thus, occurrence of a problem caused by an input error can be suppressed.

(4) As a result of the mandatory access control in the work target server 400, some kind of response is sequentially displayed regardless of whether execution of a work is allowed or denied. Specifically, a process result is displayed when execution is allowed, whereas an error message is displayed when execution is denied. Thus, the worker 503 can constantly recognize the progress of works and a result of the mandatory access control.

(5) As illustrated in FIGS. 10A and 10B, the worker 503 only needs to press the enter key to execute an ordered work, which reduces the burden on the worker 503.

(6) With the use of the work procedure manual 407 in which an unordered work is appropriately defined, a command to determine whether the work has been normally executed can be executed as necessary. Thus, an actual work procedure can be performed with some flexibility, and visual confirmation required in the maintenance work in the mission-critical server is possible. Also, even if a trouble occurs during the work procedure, the worker 503 can immediately recognize it and deal with the trouble.

(7) Even if a work to reboot the OS 403 is included in the work procedure including a series of works, the work procedure can be correctly restarted after reboot on the basis of the ID 408 and the work record 412 of the work procedure manual 407. This is the same in the case where a work to stop the work target server 400 is included in the work procedure.

(8) A work record (e.g., work record 209c) protected by a tampering preventing technique remains, and thus the correctness of the actually executed works can be verified later. Thus, the worker 503 can perform works without presence of the administrator 502 or the like.

(9) Confirmation of the work record 209c can be performed via the work result confirmation screen 340 displayed in a GUI (Graphical User Interface) as illustrated in FIG. 12, and thus the correctness of the work procedure executed in the work target server 400 can be easily verified. Of course, the work procedure can be mechanically verified by comparing the work procedure manual 207c with the data of the work record 209c by the management server 200.

The present invention is not limited to the above-described embodiments and can be variously modified. Some examples are described below.

The work procedure manuals 106 and 207a to 207c may be copied from the test server 100 to the management server 200 or from the management server 200 to the work target server 400 via a portable storage medium, instead of being transferred via a network.

The work procedure manuals 106, 207a to 207c, and 407 may have an arbitrary form. In the above-described embodiments, the work procedure manuals 207a to 207c are separated from the IDs 208a to 208c, and the work procedure manual 407 is separated from the ID 408. However, the work procedure manuals 207a to 207c and 407 that have been edited may include data of the IDs 208a to 208c and 408, respectively.

Each of the IDs 208a to 208c may have a unique character string in the management server 200. For example, arbitrary character strings generated on the basis of arbitrary information, such as the host name of the test server 100, the date and time when the work procedure manuals 207a to 207c are generated, and serial numbers counted in the management server 200, can be used as the IDs 208a to 208c.

Also, the work records 209a to 209c may have various forms in accordance with an embodiment. For example, the correspondence between the work records 209a to 209c and the IDs 208a to 208c may be realized by writing the IDs 208a to 208c in the work records 209a to 209c, or may be realized by generating the work records 209a to 209c by using file names corresponding to the IDs 208a to 208c.

When the work procedure manual 407 includes a reboot work, the “startmaintenance” command is expressly input again after the reboot in the example illustrated in FIG. 10B. However, by modifying the second embodiment in the following way, execution of the work procedure involving mandatory access control according to the work procedure manual 407 can be restarted without explicit re-input of the “startmaintenance” command.

That is, the work supporting unit 404 is preset to automatically boot up when the OS 403 boots up. Also, the work supporting unit 404 stores a login user name immediately before the reboot of the OS 403 and the ID 408 of the work procedure manual 407 used in mandatory access control immediately before the reboot in a nonvolatile storage device, such as a hard disk device.

Then, after the reboot of the OS 403, the work supporting unit 404 that is automatically rebooted obtains a login user name after the reboot and compares it with the login user name stored in the storage device immediately before the reboot. If the two user names match each other, the work supporting unit 404 automatically restarts the process illustrated in FIG. 4 from step S304.

Furthermore, the second embodiment can be modified so that replacement of formulas can be performed at another time. That is, instead of replacing formulas in step S304 in FIG. 4, an expression of a formula may be evaluated as necessary every time the access control setting 410 is generated in step S308.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium storing a control program, the control program causing the computer to execute a process comprising:
an obtaining procedure for obtaining work procedure manual information about a plurality of ordered works and one or more unordered works associated with a range of a predetermined order;
an input procedure for receiving an input to provide instructions to execute a first work;
a recognizing procedure for recognizing whether the first work matches a second work that is initially-ordered in unexecuted ordered works among the plurality of ordered works or a third work associated with a range including the order of the second work among the one or more unordered works; and
a control procedure for allowing execution of the first work if the first work matches the second work or the third work and denying execution of the first work if the first work does not match any of the second and third works.

2. The computer-readable recording medium storing a control program according to claim 1,
wherein the recognizing procedure generates control information about all the second and third works and determines whether the first work matches the second work or the third work with reference to the control information.

3. The computer-readable recording medium storing a control program according to claim 1,
wherein the range associated with each of the one or more unordered works is a global range from immediately before or after an initial order of the plurality of ordered works to immediately before or after a last order or a local range from after a specified first order to before a specified second order.

4. The computer-readable recording medium storing a control program according to claim 1,
wherein the plurality of ordered works and the one or more unordered works are represented by command character strings, and
wherein the input procedure receives a first command character string representing the first work as the input via a command line interface.

5. The computer-readable recording medium storing a control program according to claim 1,
wherein a second command character string representing the second work or a third command character string representing the third work includes an argument expressed by a predefined expression, and
wherein the recognizing procedure determines whether the first command character string matches the second command character string or the third command character string by obtaining a value of the expression.

6. The computer-readable recording medium storing a control program according to claim 1, the control program that causes the computer to execute a process further comprising:
a display procedure for displaying a second command character string representing the second work in a command line interface,
wherein, if the input procedure receives a predetermined specific input, the recognizing procedure recognizes that the second work is specified as the first work.

7. The computer-readable recording medium storing a control program according to claim 6,
wherein, if the second command character string in the work procedure manual information includes an argument expressed by a predefined expression, the display step displays the second command character string by replacing the expression by a value of the expression.

8. The computer-readable recording medium storing a control program according to claim 1, the control program that causes the computer to execute a process further comprising:
a recording procedure for generating work record information to associate the first work with a result of allowance or denial of execution of the first work in the control procedure.

9. The computer-readable recording medium storing a control program according to claim 8,
wherein the recognizing procedure specifies the second work by referring to the work record information.

10. The computer-readable recording medium storing a control program according to claim 8, the control program that causes the computer to execute a process further comprising:
a storing procedure for storing the work record information in storage means protected by a tampering protecting technique.

11. The computer-readable recording medium storing a control program according to claim 8, the control program that causes the computer to execute a process further comprising:
a transmitting procedure for transmitting the work record information to another computer that manages the work procedure manual information.

12. An information processing system comprising:
capturing unit capturing content of a plurality of works executed in a first server together with an execution order;
first generator generating work procedure manual information that associates the plurality of works as a plurality of ordered works with the order on the basis a result of capturing by the capturing unit;
first input unit receiving a first input that associates a range of order with a work;
adding unit adding the work associated in the first input received by the first input unit to the work procedure manual information generated by the first generating unit by associating the work as an unordered work with the range; and
a second server for obtaining the work procedure manual information that has been updated by the adding unit,
wherein the second server includes
second input unit receiving a second input to provide instructions to execute a first work;
recognizing unit recognizing whether the first work matches a second work that is initially-ordered in unexecuted ordered works among the plurality of ordered works or a third work that is the unordered work and that is associated with a range including the order of the second work with reference to the obtained work procedure manual information; and
controller means allowing execution of the first work if the first work matches the second work or the third work and denying execution of the first work if the first work does not match any of the second and third works.

13. The information processing system according to claim 12,
wherein the second server further includes second generator generating work record information that associates the first work with a result of allowance or denial of execution of the first work by the controller,
the information processing system further comprising display unit displaying the work procedure manual information that has been updated by the adding means and the work record information generated by the second generating means by comparing the work procedure manual information and the work record information.

14. The information processing system according to claim 12, further comprising:
transferring unit receiving an input of approving correctness of the work procedure manual information that has been updated by the adding means and transferring the approved work procedure manual information to the second server.

15. An information processing method executed by an information processing system including a first server and a second server, the information processing method comprising:
capturing content of a plurality of works executed in the first server together with an execution order;
generating work procedure manual information that associates the captured plurality of works as a plurality of ordered works with the order;
receiving a first input that associates a range of order with a work;
adding the work associated in the first input to the work procedure manual information by associating the work as an unordered work with the range;
receiving a second input to provide instructions to execute a first work;
recognizing whether the first work matches a second work that is initially-ordered in unexecuted ordered works among the plurality of ordered works or a third work that is the unordered work and that is associated with a range including the order of the second work; and
allowing execution of the first work in the second server if the first work matches the second work or the third work and denying execution of the first work in the second server if the first work does not match any of the second and third works.
